(19) United States
(12) Patent Application Publication
(10) Pub. No.: US 2015/0103216 A1
(43) Pub. Date: Apr. 16, 2015

(54) IMAGE PROCESSING DEVICE AND METHOD AND IMAGING APPARATUS

(71) Applicant: FUJIFILM Corporation, Tokyo (JP)

(72) Inventor: Hidekazu KURAHASHI, Saitama-shi (JP)

(73) Assignee: FUJIFILM CORPORATION, Tokyo (JP)

(21) Appl. No.: 14/572,881

(22) Filed: Dec. 17, 2014

Related U.S. Application Data
(63) Continuation of application No. PCT/JP2013/066251, filed on Jun. 12, 2013.

(30) Foreign Application Priority Data
Jul. 6, 2012 (JP) 2012-152674

(51) Int. Cl. H04N 9/04

(52) U.S. Cl. CPC H04N 9/045
USPC 348/280

(57) ABSTRACT

An image processing device according to the invention includes: a lens information acquisition unit; a color mixture information determination unit; mosaic image acquisition unit that, when the color mixture information determination unit determines that the color mixture information is unidentified, reads, from the color imaging element, a second mosaic image obtained by reducing the number of types of first pixels in the first mosaic image which includes a pixel of a first color formed by at least one color and a pixel of a second color formed by at least one color and in which the number of types of first pixels determined by the arrangement of pixels that are adjacent to a first pixel, which is the pixel of the first color, at a minimum pixel pitch in four directions is equal to or greater than 4; a color mixture correction unit; and a synchronization unit.

### CROSS REFERENCE TO RELATED APPLICATIONS

This application is a Continuation of PCT International Application No. PCT/JP2013/066251 filed on Jun. 12, 2013, which claims priority under 35 U.S.C §119(a) to Patent Application No. 2012-152674 filed in Japan on Jul. 6, 2012, all of which are hereby expressly incorporated by reference into the present application.

### BACKGROUND OF THE INVENTION

1. Field of the Invention

The present invention relates to an image processing device, an image processing method, and an imaging apparatus, and more particularly, to a technique for reducing or excluding the influence of color mixture between pixels on a mosaic image corresponding to the arrangement of color filters which are provided in a single imaging element.

2. Description of the Related Art

In general, color mixture occurs due to the leakage of light from adjacent pixels in an imaging element having a mosaic-shaped color filter arrangement.

There is a problem in that color reproducibility (image quality) is reduced when digital signal processing is performed on RGB color signals (which is also referred to as three-layer color data) with a large amount of color mixture to generate an image. In addition, there is a problem in that it is impossible to accurately calculate a white balance (WB) gain for WB correction from the RGB color signals with a large amount of color mixture.

JP2010-233241A and JP1996-023542A (JP-H08-023542A) disclose a technique for removing a color mixture component from a color signal including the color mixture component.

An image processing device disclosed in JP2010-233241A uses a mosaic arrangement in which green (G) signals are arranged on a checkered board to suppress noise, such as a false color.

An imaging apparatus disclosed in JP1996-023542A (JP-H08-023542A) has a structure in which red (R) filters and blue (B) filters are arranged in an offset structure for every three pixels in the horizontal direction and the vertical direction and transparent (Y) filters are arranged between the R filter and the B filter, thereby improving sensitivity and resolution.

### SUMMARY OF THE INVENTION

In some cases, when the imaging element captures light and acquires a mosaic image, light is incident through adjacent color filters and color mixture occurs. The color mixture causes color phase shift or a false signal, which results in deterioration of image quality. In particular, when the false signal is generated, a vertical stripe or a horizontal stripe appears in a portion which has not existed in the obtained image. Therefore, the deterioration of image quality due to the false signal is conspicuous.

When the amount of color mixture is known, it is possible to reduce deterioration of image quality due to the false signal by performing color mixture correction. However, the amount of color mixture largely depends on the lens of an imaging apparatus (for example, a camera or a mobile terminal with a camera function). When a lens-interchangeable imaging apparatus is used, in some cases, information required to calculate the amount of color mixture is not obtained from the lens used, which makes it difficult to perform color mixture correction.

Various new color filter arrangements have been proposed. The color filter arrangement is more complex than the Bayer arrangement which has been used. When the color filter arrangement becomes complex, color mixture correction for the mosaic image obtained from the imaging element becomes also complex.

JP2010-233241A discloses a thinning-out reading technique. However, the technique is not adapted to a new complex color filter arrangement. When a higher quality image is required, the mosaic image subjected to a thinning-out reading process is not likely to sufficiently satisfy the requirement.

JP1996-023542A (JP-H08-023542A) does not disclose the deterioration of image quality due to color mixture and a thinning-out method.

The invention has been made in view of the above-mentioned problems and an object of the invention is to provide an image processing device and method and an imaging apparatus which can suppress deterioration of image quality due to a false signal even when the amount of color mixture is unidentified and can relatively simply perform color mixture correction for a mosaic image even when a complex color filter arrangement is used.

In order to achieve the object, according to an aspect of the invention, there is provided an image processing device that generates three-layer color data on the basis of a first mosaic image obtained from a single color imaging element in which color filters are provided in a predetermined color filter arrangement on a plurality of pixels that are two-dimensionally arranged. The image processing device includes: a lens information acquisition unit that acquires information of a lens which is used to capture an image; a color mixture information determination unit that determines whether color mixture information used for color mixture correction is identified or unidentified on the basis of the lens information; mosaic image acquisition unit, when the color mixture information determination unit determines that the color mixture information is unidentified, that reads, from the color imaging element, a second mosaic image obtained by reducing the number of types of first pixels in the first mosaic image which includes a pixel of a first color formed by at least one color and a pixel of a second color formed by at least two colors other than the first color and in which the number of types of first pixels determined by the arrangement of pixels that are adjacent to a first pixel, which is the pixel of the first color, at a minimum pixel pitch in four directions is equal to or greater than 4, and when the color mixture information determination unit determines that the color mixture information is identified, that reads the first mosaic image from the color imaging element; a color mixture correction unit that performs the color mixture correction for the first mosaic image when the color mixture information determination unit determines that the color mixture information is identified; and a synchronization unit that generates colors of three layers from the first mosaic image subjected to the color mixture correction or the second mosaic image. The first color is formed by a color having a higher contribution ratio for obtaining a brightness signal than the second color.

According to the above-mentioned aspect, even when the amount of color mixture is unidentified, it is possible to suppress deterioration of image quality due to a false signal. Even when a complex color filter arrangement is used, it is possible to relatively simply perform color mixture correction for a mosaic image.

According to another aspect of the invention, there is provided an image processing device that generates three-layer color data on the basis of a first mosaic image obtained from a single color imaging element in which color filters are provided in a predetermined color filter arrangement on a plurality of pixels that are two-dimensionally arranged. The image processing device includes: a lens information acquisition unit that acquires information of a lens which is used to capture an image; a color mixture information determination unit that determines whether color mixture information used for color mixture correction is identified or unidentified on the basis of the lens information; a mosaic image acquisition unit that reads the first mosaic image from the color imaging element; a mosaic image generation unit, when the color mixture information determination unit determines that the color mixture information is unidentified, that generates a second mosaic image obtained by reducing the number of types of first pixels in the first mosaic image which includes a pixel of a first color formed by at least one color and a pixel of a second color formed by at least two colors other than the first color and in which the number of types of first pixels determined by the arrangement of pixels that are adjacent to a first pixel, which is the pixel of the first color, at a minimum pixel pitch in four directions is equal to or greater than 4; a color mixture correction unit that performs the color mixture correction for the first mosaic image when the color mixture information determination unit determines that the color mixture information is identified; and a synchronization unit that generates colors of three layers from the first mosaic image subjected to the color mixture correction or the second mosaic image. The first color is formed by a color having a higher contribution ratio for obtaining a brightness signal than the second color.

According to the above-mentioned aspect, even when the amount of color mixture is unidentified, it is possible to suppress deterioration of image quality due to a false signal. Even when a complex color filter arrangement is used, it is possible to relatively simply perform color mixture correction for a mosaic image.

According to still another aspect of the invention, there is provided an image processing method that generates three-layer color data on the basis of a first mosaic image obtained from a single color imaging element in which color filters are provided in a predetermined color filter arrangement on a plurality of pixels that are two-dimensionally arranged. The image processing method includes: a lens information acquisition step of acquiring information of a lens which is used to capture an image; a color mixture information determination step of determining whether color mixture information used for color mixture correction is identified or unidentified on the basis of the lens information; a mosaic image acquisition step of, when the color mixture information is determined to be unidentified in the color mixture information determination step, reading, from the color imaging element, a second mosaic image obtained by reducing the number of types of first pixels in the first mosaic image which includes a pixel of a first color formed by at least one color and a pixel of a second color formed by at least two colors other than the first color and in which the number of types of first pixels determined by the arrangement of pixels that are adjacent to a first pixel, which is the pixel of the first color, at a minimum pixel pitch in four directions is equal to or greater than 4, and when the color mixture information is determined to be identified in the color mixture information determination step, reading the first mosaic image from the color imaging element; a color mixture correction step of performing the color mixture correction for the first mosaic image when the color mixture information is determined to be identified in the color mixture information determination step; and a synchronization step of generating colors of three layers from the first mosaic image subjected to the color mixture correction or the second mosaic image. The first color is formed by a color having a higher contribution ratio for obtaining a brightness signal than the second color.

According to the above-mentioned aspect, even when the amount of color mixture is unidentified, it is possible to suppress deterioration of image quality due to a false signal. Even when a complex color filter arrangement is used, it is possible to relatively simply perform color mixture correction for a mosaic image.

According to yet another aspect of the invention, there is provided an image processing method that generates three-layer color data on the basis of a first mosaic image obtained from a single color imaging element in which color filters are provided in a predetermined color filter arrangement on a plurality of pixels that are two-dimensionally arranged. The image processing method includes: a lens information acquisition step of acquiring information of a lens which is used to capture an image; a color mixture information determination step of determining whether color mixture information used for color mixture correction is identified or unidentified on the basis of the lens information; a mosaic image acquisition step of, when the color mixture information is determined to be unidentified in the color mixture information determination step, reading, from the color imaging element, a second mosaic image obtained by reducing the number of types of first pixels in the first mosaic image which includes a pixel of a first color formed by at least one color and a pixel of a second color formed by at least two colors other than the first color and in which the number of types of first pixels determined by the arrangement of pixels that are adjacent to a first pixel, which is the pixel of the first color, at a minimum pixel pitch in four directions is equal to or greater than 4, and when the color mixture information is determined to be identified in the color mixture information determination step, reading the first mosaic image from the color imaging element; a color mixture correction step of performing the color mixture correction for the first mosaic image when the color mixture information is determined to be identified in the color mixture information determination step; and a synchronization step of generating colors of three layers from the first mosaic image subjected to the color mixture correction or the second mosaic image. The first color is formed by a color having a higher contribution ratio for obtaining a brightness signal than the second color.

According to the above-mentioned aspect, even when the amount of color mixture is unidentified, it is possible to suppress deterioration of image quality due to a false signal. Even when a complex color filter arrangement is used, it is possible to relatively simply perform color mixture correction for a mosaic image.

According to the invention, even when the amount of color mixture is unidentified, it is possible to suppress deterioration of image quality due to a false signal. Even when a complex color filter arrangement is used, it is possible to relatively simply perform color mixture correction for a mosaic image.

### BRIEF DESCRIPTION OF THE DRAWINGS

FIG. 1 is a diagram illustrating the cause of color mixture.

FIG. 2 is a functional block diagram illustrating an example of an imaging apparatus according to the invention.

FIG. 3 is a functional block diagram illustrating an example of an image processing device according to the invention.

FIG. 4 is a diagram illustrating the flow of a processing operation of an example of the image processing device according to the invention.

FIG. 5 is a functional block diagram illustrating an example of the image processing device according to the invention.

FIG. 6 is a diagram illustrating the flow of a processing operation of an example of the image processing device according to the invention.

FIG. 7 is a diagram illustrating the flow of a processing operation of an example of the image processing device according to the invention.

FIG. 8 is a diagram illustrating the flow of a processing operation of an example of the image processing device according to the invention.

FIGS. 9A and 9B are diagrams illustrating a method of classifying types of G filters in a Bayer arrangement.

FIG. 10 is a diagram illustrating a new color filter arrangement.

FIG. 11 is a diagram illustrating a new color filter arrangement.

FIGS. 12A and 12B are diagrams illustrating the type of first pixels in a new color filter arrangement.

FIGS. 13A to 13C are diagrams illustrating another method of classifying the types of first pixels.

FIG. 14 is a table illustrating another method of classifying the types of first pixels in a new color filter arrangement.

FIGS. 15A and 15B are diagrams illustrating an example of a process of reducing the number of types of first pixels according to the invention.

FIG. 16 is a diagram illustrating an example of a mosaic image after the process of reducing the number of types of first pixels.

FIGS. 17A and 17B are diagrams illustrating an example of the process of reducing the number of types of first pixels according to the invention.

FIG. 18 is a diagram illustrating an example of a mosaic image after the process of reducing the number of types of first pixels.

FIGS. 19A and 19B are diagrams illustrating an example of the process of reducing the number of types of first pixels according to the invention.

FIGS. 20A and 20B are diagrams illustrating an example of the process of reducing the number of types of first pixels according to the invention.

FIGS. 21A and 21B are diagrams illustrating an example of the process of reducing the number of types of first pixels according to the invention.

FIGS. 22A and 22B are diagrams illustrating an example of the process of reducing the number of types of first pixels according to the invention.

FIGS. 23A and 23B are diagrams illustrating an example of the process of reducing the number of types of first pixels according to the invention.

FIGS. 24A and 24B are diagrams illustrating an example of the process of reducing the number of types of first pixels according to the invention.

FIGS. 25A and 25B are diagrams illustrating an example of the process of reducing the number of types of first pixels according to the invention.

FIGS. 26A and 26B are diagrams illustrating an example of the process of reducing the number of types of first pixels according to the invention.

FIGS. 27A and 27B are diagrams illustrating an example of the process of reducing the number of types of first pixels according to the invention.

FIGS. 28A and 28B are diagrams illustrating an example of the process of reducing the number of types of first pixels according to the invention.

FIG. 29 is a diagram illustrating an embodiment of the imaging apparatus according to the invention.

FIG. 30 is a block diagram illustrating the structure of the imaging apparatus illustrated in FIG. 29.

### DESCRIPTION OF THE PREFERRED EMBODIMENTS

Hereinafter, embodiments of an image processing device and method and an imaging apparatus according to the invention will be described with reference to the accompanying drawings.

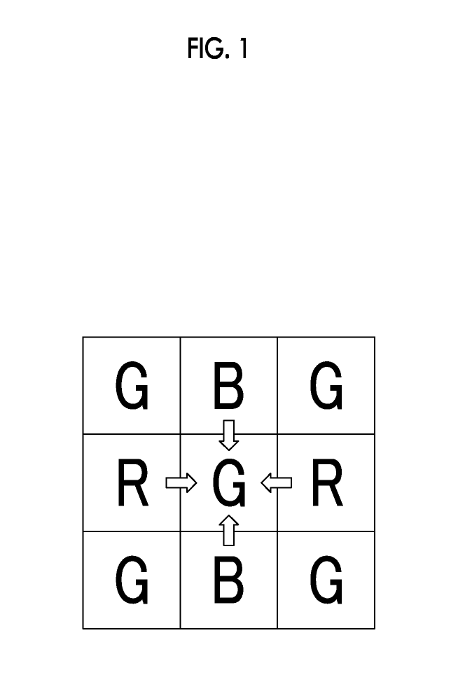

First, color mixture will be described in the invention. FIG. 1 is a diagram illustrating the cause of the color mixture. As illustrated in FIG. 1, the color mixture occurs due to colors entering pixels which are adjacent at a minimum pixel pitch in the horizontal and vertical directions. Here, the minimum pixel pitch unit that a pixel pitch from a central point of a reference pixel to a central point of an adjacent pixel is the minimum. In addition, four directions at the minimum pixel pitch are the left, right, top, and bottom of the reference pixel when one pixel has a square shape.

A first direction and a second direction which is perpendicular to the first direction in a mosaic image can be the vertical direction and the horizontal direction in FIG. 1. In the invention, a first color and a second color are used. The first color is formed by a color with a higher contribution ratio for obtaining a brightness signal than the second color. For example, examples of the first color include green (G), white, clear, and emerald. However, the invention is not limited thereto. In addition, the first color is not limited to one color. For example, the first color may include two types of Gs different from G(1) and G(2) or it may be another color. The second color is a color with a relatively low contribution ratio for obtaining a brightness signal. Specifically, the second color is, for example, red (R) or blue (B). However, the second color is not limited thereto.

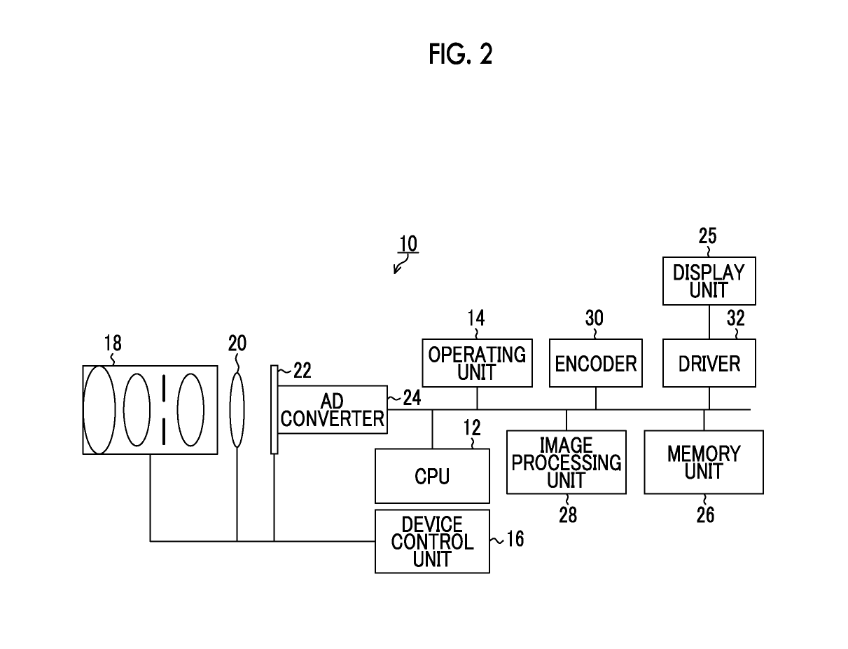

FIG. 2 is a functional block diagram illustrating an example of an imaging apparatus according to the invention.

An imaging apparatus 10 is a digital camera which stores a captured image in an internal memory (memory unit 26) or an external recording medium (not illustrated). The overall operation of the imaging apparatus 10 is controlled by a central processing unit (CPU) 12.

The imaging apparatus 10 is provided with an operation unit 14 including, for example, a shutter button (shutter switch), a mode dial, a reproduction button, a MENU/OK key, an arrow key, a zoom button, and a BACK key. A signal output from the operation unit 14 is input to the CPU 12. The CPU 12 controls each circuit of the imaging apparatus 10 on the basis of the input signal. For example, the CPU 12 controls a lens unit 18, a shutter 20, and an imaging element 22 which functions as image acquisition unit through a device control unit 16 and controls an imaging operation, image processing, image data recording and reproduction, and the display operation of a display unit 25.

The lens unit 18 includes, for example, a focus lens, a zoom lens, and a diaphragm. The flux of light which passes through the lens unit 18 and the shutter 20 is focused on a light receiving layer of the imaging element 22.

The imaging element 22 (hereinafter, referred to as a color imaging element) is a color image sensor of a complementary metal-oxide semiconductor (CMOS) type, an XY address type, or a charge coupled device (CCD) type. In the imaging element 22, a plurality of light receiving elements (photodiodes) are two-dimensionally arranged. An object image which is formed on the light receiving layer of each photodiode is converted into a signal voltage (or charge) corresponding to the amount of incident light of the object image.

A signal charge which is stored in the imaging element 22 is read as a voltage signal corresponding to the signal charge on the basis of a read signal transmitted from the device control unit 16. The voltage signal read from the imaging element 22 is transmitted to an A/D converter 24. The A/D converter 24 sequentially converts the voltage signal into digital R, G, and B signals corresponding to the arrangement of color filters. The digital R, G, and B signals are temporarily stored in the memory unit 26.

The memory unit 26 includes, for example, an SDRAM which is a volatile memory and an EEPROM (storage unit) which is a rewritable non-volatile memory. The SDRAM is used as a work area when the CPU 12 executes a program and is also used as a storage area which temporarily stores a captured and acquired digital image signal. The EEPROM stores, for example, a camera control program including an image processing program and various parameters or tables which are used for image processing including defect information of the pixels of the imaging element 22 and color mixture correction.

An image processing device 28 performs predetermined signal processing, such as color mixture correction, white balance correction, a gamma correction process, and a synchronization process (which is also referred to as a demosaic process), and RGB/YC conversion, on the digital image signal which is temporarily stored in the memory unit 26. The details of the image processing device according to the invention (which is described as the image processing unit 28 in FIG. 2 and is, hereinafter, referred to as an image processing device) will be described below.

An encoder 30 encodes the image data processed by the image processing device 28 into image display data. The image display data is output to a display unit 25 which is provided on the rear side of the camera through a driver 32. Then, the object image is continuously displayed on a display screen of the display unit 25.

When the shutter button of the operation unit 14 is pressed in a first step (halfway), the CPU 12 performs control such that an AF operation and an AE operation start and the device control unit 16 moves the focus lens of the lens unit 18 to a focal position in an optical axis direction.

The image processing device 28 appropriately reads the image data which is temporarily stored in the memory unit 26 and performs predetermined signal processing, such as color mixture correction, white balance correction, gamma correction, a synchronization process, and RGB/YC conversion. The RGB/YC-converted image data (YC data) is compressed in a predetermined compression format (for example, a JPEG format) and the compressed image data is recorded in a predetermined image file (for example, Exiffile) format in the internal memory or the external memory.

Various types of imaging apparatuses are considered as the imaging apparatus 10. For example, there is a digital camera or a mobile terminal apparatus with an imaging function. Examples of the mobile terminal apparatus include mobile phones, smart phones, personal digital assistants (PDA), and portable game machines.

### First Embodiment

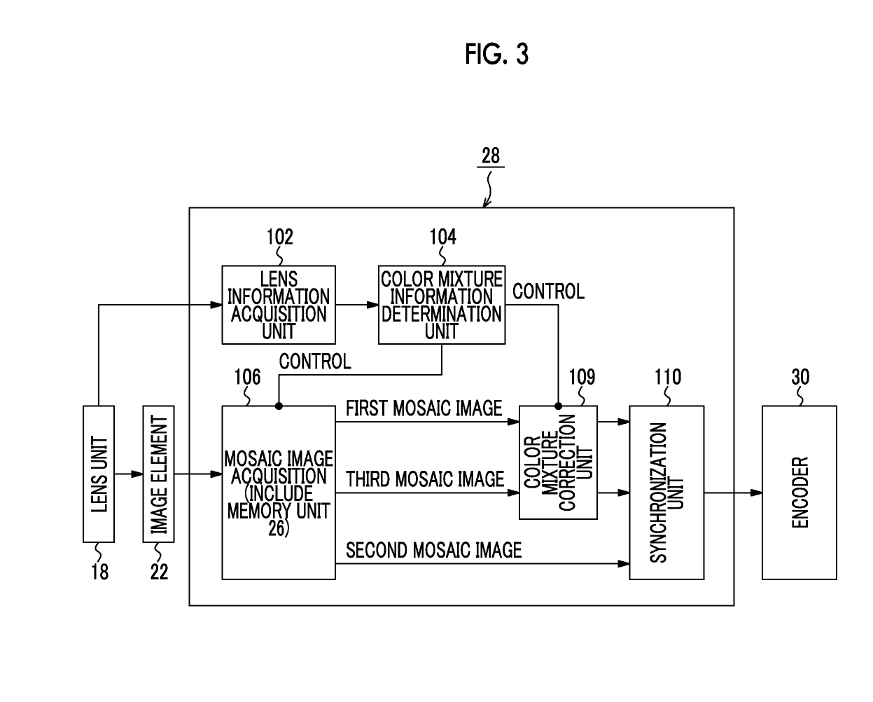

FIG. 3 is a block diagram illustrating a main portion of the internal structure of a first embodiment of the image processing device 28 provided in the imaging apparatus 10 illustrated in FIG. 2.

As illustrated in FIG. 3, the image processing device 28 includes, as main components, a lens information acquisition unit 102, a color mixture information determination unit 104 (corresponding to color mixture information determination unit), a mosaic image acquisition unit 106 (corresponding to mosaic image acquisition unit), a color mixture correction unit 109 (corresponding to color mixture correction unit), and a synchronization unit 110 (corresponding to synchronization unit). The concept of the mosaic image acquisition unit 106 illustrated in FIG. 3 includes the memory unit 26 illustrated in FIG. 2. In addition, the image processing device 28 may include a white balance correction unit, a signal processing unit which performs signal processing, such as gamma correction and RGB/YC conversion, an RGB integration unit, and a white balance (WB) gain calculation unit (white balance gain calculation unit), which are not illustrated in the drawings and will be appropriately described in the invention, if necessary.

In the image processing device 28, the lens information acquisition unit 102 acquires lens information which is used by the lens unit 18 to capture images. Here, the lens information basically means information indicating whether the color mixture information determination unit 104 can perform color mixture correction. A process of determining whether the color mixture correction can be performed on the basis of the lens information will be described below.

The lens information obtained by the lens information acquisition unit 102 is transmitted to the color mixture information determination unit 104. The color mixture information determination unit 104 determines whether the color mixture correction can be performed on the basis of the obtained lens information. That is, since color mixture information (the amount of color mixture or a color mixture ratio) is determined by the lens information in many cases, the color mixture information determination unit 104 can determine whether the color mixture correction can be performed on the basis of the lens information.

Specifically, the color mixture information (the amount of color mixture or the color mixture ratio) can be determined or acquired by incident angle data for an incident beam which results from the lens used and optical information of the imaging element. In some cases, the incident angle data for the incident beam varies depending on each setting, such as a focal length, an aperture, and the distance to a focus. Therefore, it is possible to acquire the incident angle data for the incident beam corresponding to each setting.

In addition, the following examples can be given as the lens information.

As a first example, the incident angle data for the incident beam related to each setting, such as the focal length, the aperture, and the distance to the focus, is stored in a lens. When the incident angle data is directly read from the lens, the read incident angle data becomes the lens information.

As a second example, the incident angle data for the incident beam which is related to each setting of a plurality of types of lenses, such as a focal length, an aperture, and the distance to a focus, is stored in the color mixture information determination unit 104 in advance. Then, information about a lens type is obtained from the lens to be used (or has been used). When the incident angle data corresponding to the lens type is read, the information about the lens type becomes the lens information.

As a third example, information about the incident angle data for the incident beam which is related to each setting of a lens, such as a focal length, an aperture, and the distance to a focus, is read from the lens. When the color mixture information determination unit 104 calculates the incident angle data on the basis of the information, the information about the incident angle data becomes the lens information.

The characteristics of the imaging element which result from, for example, the structure of a micro lens or a photodiode and the position of the photodiode can be given as an example of the optical information of the imaging element.

The color mixture information determination unit 104 acquires the lens information from the mounted lens. When the color mixture information (the amount of color mixture or the color mixture ratio) can be calculated by the lens information, the color mixture information determination unit 104 determines that the color mixture information is identified. When the color mixture information cannot be calculated, the color mixture information determination unit 104 determines that the color mixture information is unidentified. In addition, when communication with the mounted lens is not available, the color mixture information determination unit 104 determines that the color mixture information is unidentified. The above description is mainly related to a case in which the lens is interchanged. When the lens is not interchanged, the color mixture information determination unit 104 determines that the color mixture information is identified, without acquiring the lens information.

When the color mixture information determination unit 104 determines that the color mixture information is identified, the color mixture correction unit 109 performs color mixture correction on the basis of the color mixture information. As described above, when the lens to be used is predicted, the color mixture information determination unit 104 can calculate the amount of color mixture from information, such as the focal length of the lens and the minimum and/or maximum aperture value and perform the color mixture correction. However, when the lens to be used is not predicted, the amount of color mixture is unidentified and it is difficult to perform the color mixture correction.

A mosaic image which is read from the color imaging element 22 is temporarily stored in the mosaic image acquisition unit 106. The mosaic image acquisition unit 106 is controlled by the color mixture information determination unit 104. The mosaic image acquisition unit 106 can change the mosaic image read from the color imaging element 22 on the basis of the determination result of the color mixture information determination unit 104. For example, when the color mixture information determination unit 104 determines that the color mixture information is identified, the mosaic image acquisition unit 106 acquires a first mosaic image.

Here, the first mosaic image is a mosaic image that is obtained from a single color imaging element in which color filters are provided in a predetermined color filter arrangement on a plurality of two-dimensionally arranged pixels and includes a pixel of a first color which is formed by at least one color and a pixel of a second color which is formed by at least two colors other than the first color. The first color is formed by a color that has a higher contribution ratio for obtaining a brightness signal than the second color.

When the color mixture information determination unit 104 determines that the color mixture information is identified and then the mosaic image acquisition unit 106 acquires the first mosaic image, the first mosaic image is transmitted to the color mixture correction unit 109.

The color mixture correction unit 109 performs the color mixture correction for the first mosaic image on the basis of the color mixture information which is determined to be identified. Here, the color mixture correction means a process of correcting color mixture. For example, when the amount of color mixture is known in advance, the color mixture correction unit 109 can perform the color mixture correction according to the amount of color mixture.

After the color mixture correction unit 109 performs the color mixture correction, the first mosaic image is transmitted to the synchronization unit 110.

On the other hand, when the color mixture information determination unit 104 determines that the color mixture information is unidentified, the mosaic image acquisition unit 106 acquires a second mosaic image.

Here, the second mosaic image means a mosaic image obtained by a process of reducing the number of types of first pixels in the first mosaic image on the first mosaic image when the color mixture information determination unit 104 determines that the color mixture information is unidentified. The type of first pixels means the type of first pixels that is determined by the arrangement of pixels adjacent to a first pixel, which is a pixel of the first color, at a minimum pixel pitch in four directions. The type of first pixels will be described in detail below.

When the color mixture information determination unit 104 determines that the color mixture information is unidentified and then the mosaic image acquisition unit 106 acquires the second mosaic image, the second mosaic image is transmitted to the synchronization unit 110.

The synchronization unit 110 performs a synchronization process on the first mosaic image and the second mosaic image to generate three-layer color data. The synchronization process interpolates the spatial deviation of a color signal caused by the arrangement of the single color filter to convert the color signal into three-layer color data. An interpolation method is not limited to one aspect. Directional interpolation or weighted interpolation may be performed and various types of interpolation may be performed depending on image quality and the performance of an apparatus which performs the synchronization process. For example, a synchronization process considering the characteristics of the mosaic image may be performed.

Specifically, the consideration of the mosaic image unit performs the synchronization process considering the arrangement of the first pixels in the mosaic image.

The three-layer color data generated by the synchronization unit 110 is transmitted to the encoder 30 which is provided outside the image processing device 28.

The image processing device 28 performs the following other processes in order to process an image, which will not be described in detail for convenience of explanation.

Before the synchronization process, offset correction or white balance correct (WB correction) may be performed. In the offset correction, a process of aligning black levels is performed on the first mosaic image. In the white balance correction, the first mosaic image is analyzed to specify, for example, the type of light source (for example, sunlight, a fluorescent lamp, and a tungsten lamp) and gain values Rg, Gg, and Bg for white balance correction are set to gain values Rg, Gg, and Bg which are stored in advance so as to correspond to the type of light source. Alternatively, the gain values Rg, Gg, and Bg for white balance correction are set to gain values Rg, Gg, and Bg corresponding to the type of light source or a color temperature which is manually selected on the menu screen for the white balance correction.

After the synchronization process, the signal processing unit performs signal processing, such as RGB/YC conversion, to convert the obtained three-layer color data into a brightness signal Y and color difference signals Cr and Cb. The processed brightness signal Y and color difference signals Cr and Cb are converted and output.

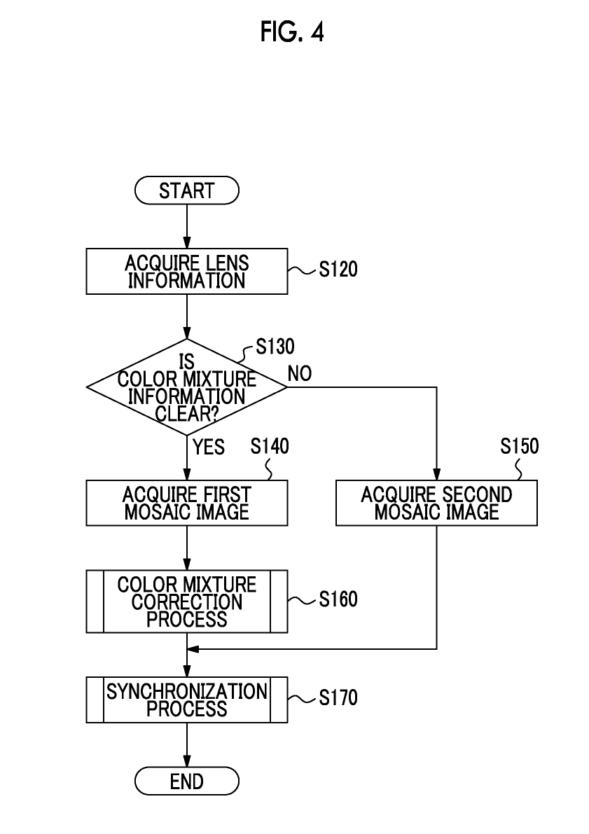

FIG. 4 is the flow of the processing operation of the image processing device 28 according to the first embodiment.

In FIG. 4, first, the image processing device 28 acquires the lens information using the lens unit 18 (Step S120). Then, the color mixture information determination unit 104 determines whether the color mixture information is identified on the basis of the obtained lens information (Step S130). When the color mixture information determination unit 104 determines that the color mixture information is identified (Yes in Step S130), the mosaic image acquisition unit 106 acquires the first mosaic image (Step S140). On the other hand, when the color mixture information determination unit 104 determines that the color mixture information is unidentified (No in Step S130), the mosaic image acquisition unit 106 acquires the second mosaic image (Step S150).

Then, when the color mixture information determination unit 104 determines that the color mixture information is identified (Yes in Step S130), the color mixture correction unit 109 performs a color mixture correction process on the first mosaic image (Step S160).

The synchronization unit 110 performs the synchronization process on the first mosaic image or the second mosaic image subjected to the color mixture correction process (Step S160) (Step S170). Three-layer color data is obtained by the synchronization process (Step S170). Then, the operation of the image processing device 28 ends.

### Second Embodiment

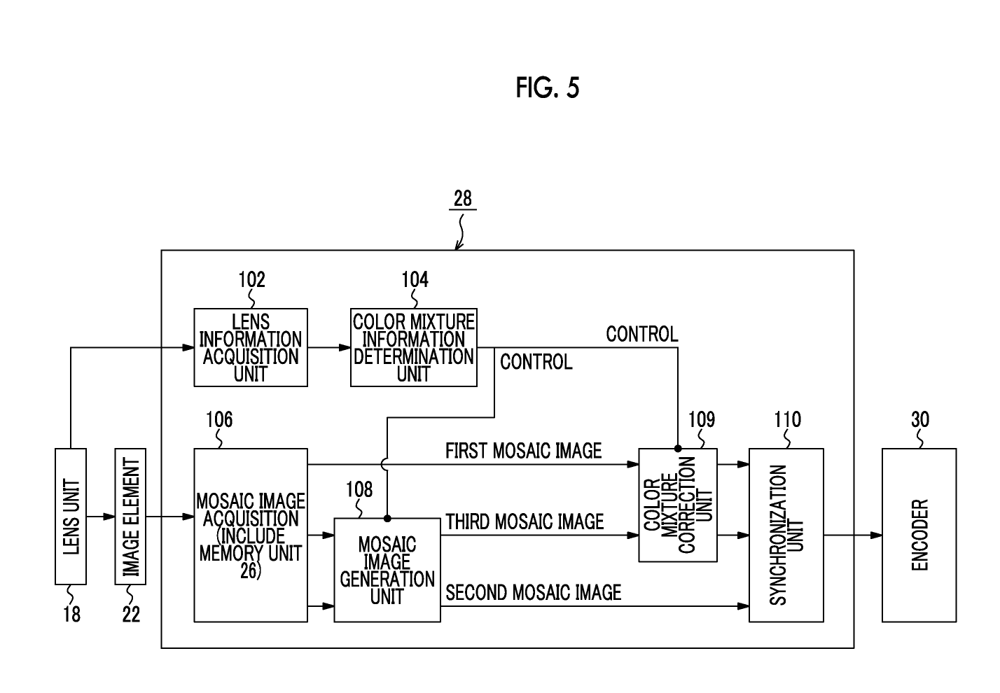

FIG. 5 is a functional block diagram illustrating a second embodiment of the image processing device 28. In the second embodiment, the same components in the image processing device as those in the first embodiment (FIG. 3) are denoted by the same reference numerals and the detailed description thereof will not be repeated.

The image processing device 28 according to the second embodiment differs from the image processing device 28 (FIG. 3) according to the first embodiment in that a mosaic image generation unit 108 which is controlled by a color mixture information determination unit 104 is added and the color mixture information determination unit 104 according to the second embodiment does not control a mosaic image acquisition unit 106. Therefore, the mosaic image acquisition unit 106 according to the second embodiment constantly reads a first mosaic image, regardless of the determination result of the color mixture information determination unit 104.

When the color mixture information determination unit 104 determines that color mixture information is identified, a first mosaic image acquired by the mosaic image acquisition unit 106 is transmitted to a color mixture correction unit 109. The color mixture correction unit 109 performs color mixture correction for the first mosaic image. Then, the first mosaic image is transmitted to a synchronization unit 110.

On the other hand, when the color mixture information determination unit 104 determines that the color mixture information is unidentified, the mosaic image generation unit 108 acquires the first mosaic image from the mosaic image acquisition unit 106 and generates a second mosaic image.

When the color mixture information determination unit 104 determines that the color mixture information is unidentified and the mosaic image generation unit 108 acquires the second mosaic image, the second mosaic image is transmitted to the synchronization unit 110.

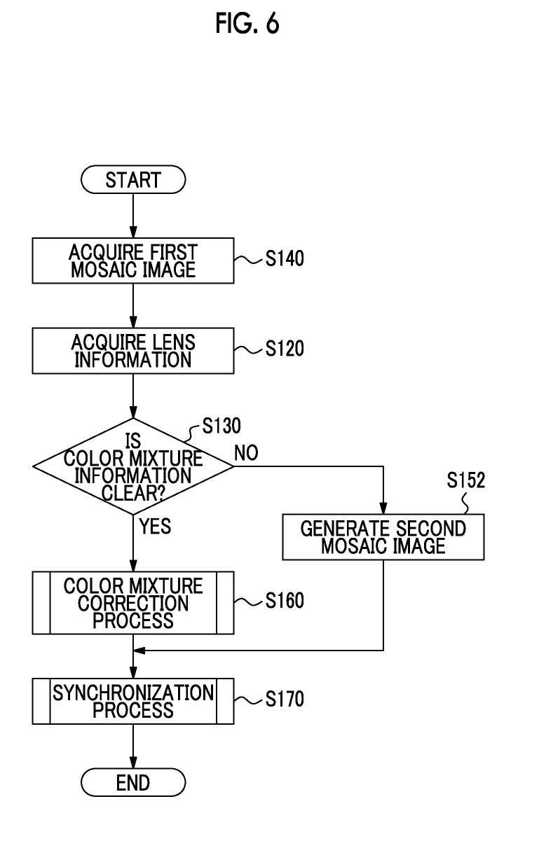

FIG. 6 is the flow of the processing operation of the image processing device 28 according to the second embodiment. The same components as those in the first embodiment (FIG. 4) are denoted by the same reference numerals and the description thereof will not be repeated.

The flow of the processing operation according to the second embodiment illustrated in FIG. 6 differs from the flow of the processing operation according to the first embodiment illustrated in FIG. 4 in that (Step S152) of generating the second mosaic image is added, an operation (Step S150) of acquiring the second mosaic image is removed, and an operation (Step S140) of acquiring the first mosaic image is an initial processing operation.

First, in the second embodiment illustrated in FIG. 6, the mosaic image acquisition unit 106 acquires the first mosaic image (Step S140). When the color mixture information determination unit 104 determines that the color mixture information is unidentified (No in Step S130), the mosaic image generation unit 108 generates the second mosaic image (Step S152). The second mosaic image generated by the mosaic image generation unit 108 is transmitted to the synchronization unit 110 and the synchronization process is performed on the second mosaic image. On the other hand, when the color mixture information determination unit 104 determines that the color mixture information is identified (Yes in Step S130), a color mixture correction process (Step S160) is performed on the first mosaic image obtained in Step S140.

### Third Embodiment

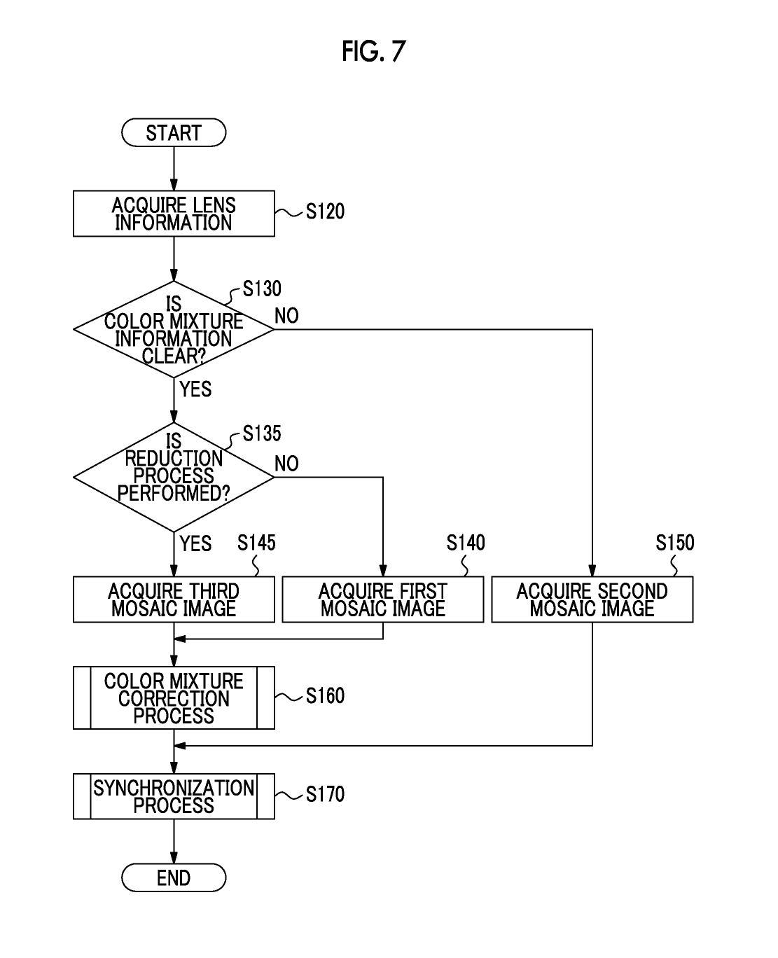

FIG. 7 illustrates the flow of a processing operation of an image processing device 28 according to a third embodiment. A functional block diagram of the image processing device is the same as that of the image processing device according to the first embodiment (FIG. 3). The same components are denoted by the same reference numerals and the detailed description thereof will not be repeated.

In FIG. 3, in the third embodiment, when a color mixture information determination unit 104 determines that color mixture information is identified, a mosaic image acquisition unit 106 reads a first mosaic image from a color imaging element 22 or the mosaic image acquisition unit 106 reads a third mosaic image obtained by reducing the number of types of first pixels from the color imaging element 22 (see FIG. 3). Then, the third mosaic image is transmitted to a color mixture correction unit 109.

According to the third embodiment, even when the color mixture information is identified and color mixture correction can be performed, a process of reducing the number of types of first pixels can be performed to simplify the color mixture correction.

FIG. 7 illustrates the flow of the processing operation according to the third embodiment. The same components as those in the flow of the processing operation (FIG. 4) according to the first embodiment are denoted by the same reference numerals and the detailed description thereof will not be repeated.

In the third embodiment, when the color mixture information determination unit 104 determines that the color mixture information is identified (Yes in Step S130) and when the color mixture information determination unit 104 determines to perform the process of reducing the number of types of first pixels (Yes in Step S135), a process of reducing the number of types of first pixels from the first mosaic image is performed to obtain the third mosaic image (Step S145). Then, a color mixture correction process (Step S160) is performed on the third mosaic image.

When the color mixture information determination unit 104 determines to perform the process of reducing the number of types of first pixels, the process is automatically or manually performed. The following selection is automatically or manually performed. For example, when image quality is selected in response to a request from the user and a high-resolution image is required, the process of reducing the number of types of first pixels is not performed (No in Step S135) and the first mosaic image is acquired (Step S140). When the user does not require a very high resolution image and wants to perform a relatively simple correction process, the process of reducing the number of types of first pixels is performed (Yes in Step S135) and the third mosaic image is acquired (Step S145).

### Fourth Embodiment

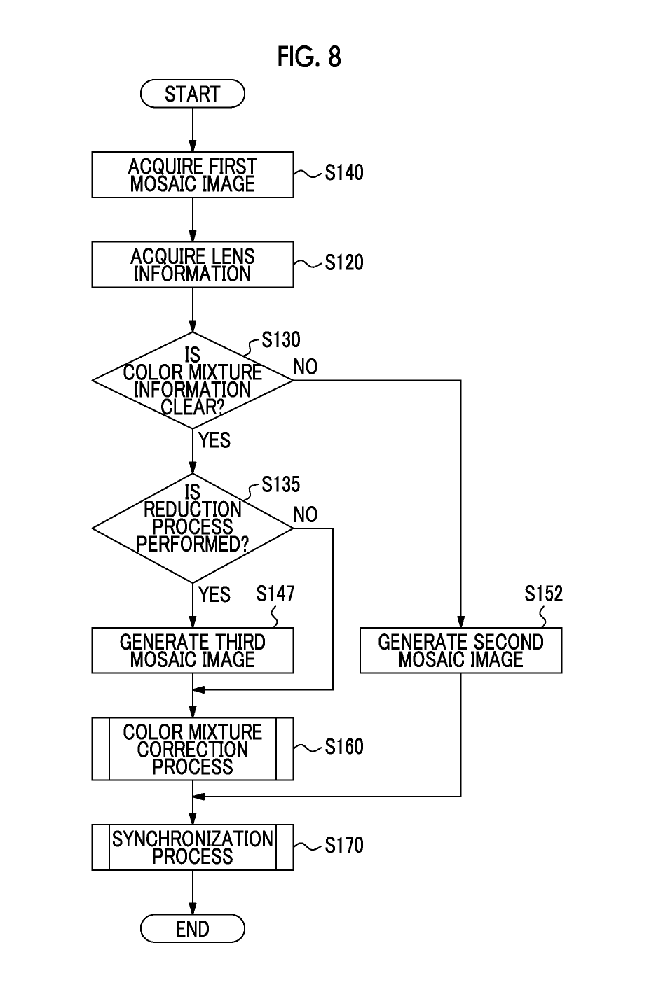

FIG. 8 illustrates the flow of a processing operation of an image processing device 28 according to a fourth embodiment. A functional block diagram of the image processing device according to the fourth embodiment is the same as that of the image processing device according to the second embodiment (FIG. 5). The same components as those in the second embodiment are denoted by the same reference numerals and the detailed description thereof will not be repeated.

In the fourth embodiment, when a color mixture information determination unit 104 determines that color mixture information is identified, a first mosaic image acquired by a mosaic image acquisition unit 106 is transmitted to a color mixture correction unit 109 or a mosaic image generation unit 108 reads a third mosaic image obtained by reducing the number of types of first pixels from a color imaging element 22 (see FIG. 5). Then, the third mosaic image is transmitted to a color mixture correction unit 109.

According to the fourth embodiment illustrated in FIG. 5, even when the color mixture information is identified and the color mixture correction can be performed, a process of reducing the number of types of first pixels can be performed to simplify color mixture correction.

FIG. 8 illustrates the flow of the processing operation according to the fourth embodiment. The same components as those in the flow of the processing operation (FIG. 6) according to the second embodiment are denoted by the same reference numerals and the detailed description thereof will not be repeated.

In the fourth embodiment, when the color mixture information determination unit 104 determines that the color mixture information is identified (Yes in Step S130) and when the color mixture information determination unit 104 determines to perform the process of reducing the number of types of first pixels (Yes in Step S135), a process of reducing the number of types of first pixels from the first mosaic image is performed to generate the third mosaic image (Step S147). Then, a color mixture correction process (Step S160) is performed on the third mosaic image.

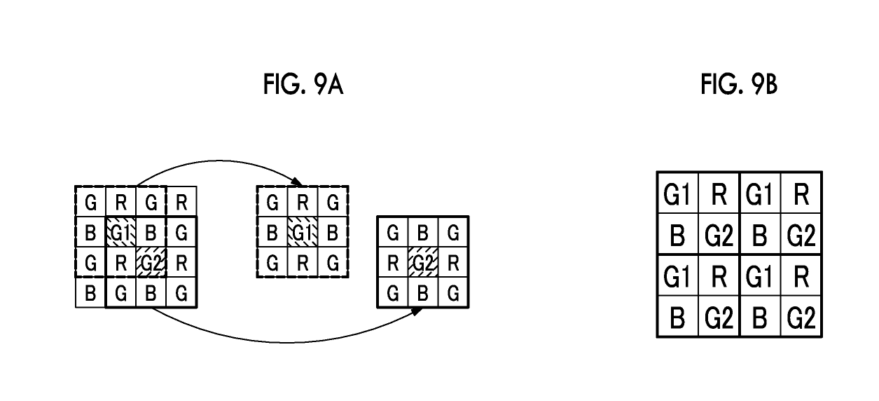

FIG. 9A illustrates the type of first pixels (in this case, green (G)) in a Bayer arrangement. As can be seen from FIG. 9A, there are two types of first pixels, that is, G1 and G2, considering the arrangement of four pixels which are adjacent at the minimum pixel pitch. Specifically, Bs are adjacent to the left and right sides of G1 and Rs are adjacent to the upper and lower sides of G1. In contrast, Rs are adjacent to the left and right sides of G2 and Bs are adjacent to the upper and lower sides of G2. Therefore, as illustrated in FIG. 9B, there are two types of first pixels in the Bayer arrangement.

In the invention, a target is four or more types of first pixels in the first mosaic image which has not been subjected to the process of reducing the number of types of first pixels and has been subjected to a process of reading all pixels in an effective imaging region. Therefore, in a mosaic image including a large number of types of first pixels, it is possible to prevent a process for preventing deterioration of image quality from being complicated.

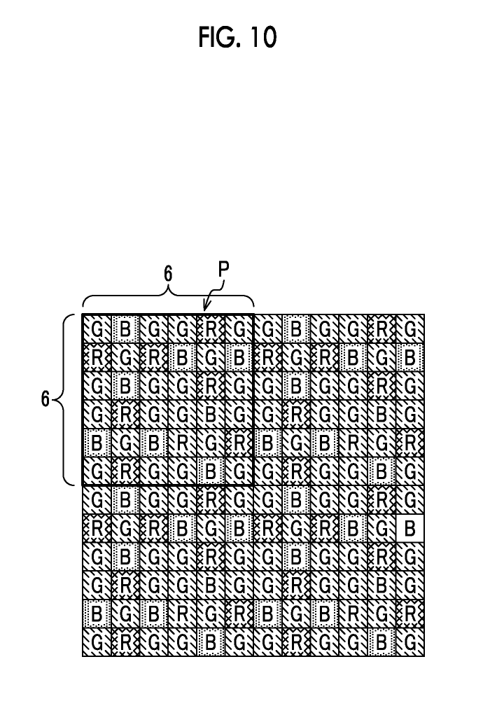

FIG. 10 is a diagram illustrating an embodiment of an imaging element 22 (including a photodiode and a color filter). In particular, FIG. 10 illustrates a new arrangement of color filters on a light receiving surface of the imaging element 22. Here, the color filter arrangement is the same as the arrangement of first color pixels and second color pixels in the mosaic image. That is, when all pixels are read from the imaging element 22, the color filter arrangement is the same as the arrangement of the first color pixels and the second color pixels in the first mosaic image.

The color filter arrangement of the imaging element 22 includes a basic arrangement pattern P (a pattern represented by a thick frame) which is a square arrangement pattern corresponding to M×N (6×6) pixels. The basic arrangement pattern P is repeatedly arranged in the horizontal direction and the vertical direction. That is, in the color filter arrangement, red (R), green (G), and blue (B) filters (an R filter, a G filter, and a B filter) are arranged so as to have a predetermined periodicity. As such, since the R filter, the G filter, and the B filters are arranged so as to have a predetermined periodicity, image processing can be performed on an RGB mosaic image which is read from the imaging element 22 on the basis of a repetitive pattern.

In the color filter arrangement illustrated in FIG. 10, one or more G filters which correspond to a color having the highest contribution to obtaining a brightness signal (in this embodiment, the G color) are arranged in each line in the horizontal direction, the vertical direction, an oblique upper right (NE) direction, and an oblique upper left (NW) direction of the color filter arrangement.

NE means an oblique upper right direction and NW means an oblique lower right direction. For example, in the case of a square pixel arrangement, the oblique upper right direction and the oblique lower right direction are inclined at an angle of 45° with respect to the horizontal direction. In a rectangular pixel arrangement, the angle is changed depending on the lengths of a long side and a short side in the diagonal direction of the rectangle.

Since the G filters corresponding to brightness-based pixels are arranged in each line in the horizontal, vertical, and oblique (NE and NW) directions of the color filter arrangement, it is possible to improve the degree of reproducibility of a synchronization process in a high-frequency range, regardless of a high-frequency direction.

In the color filter arrangement illustrated in FIG. 10, one or more R filters and one or more B filters corresponding to two or more colors (in this embodiment, R and B colors) other than the G color are arranged in each line in the horizontal and vertical directions of the basic arrangement pattern.

Since the R filters and the B filters are arranged in each line in the horizontal and vertical directions of the color filter arrangement, it possible to reduce the generation of a false color (color moire). Therefore, it is possible to omit an optical low-pass filter for reducing (suppressing) the generation of a false color. Even when the optical low-pass filter is applied, it is possible to apply an optical low-pass filter which has a low high-frequency component cutting performance for preventing the generation of the false color and thus to prevent a reduction in resolution.

In the basic arrangement pattern P of the color filter arrangement illustrated in FIG. 10, 8 R pixels, 20 G pixels, and 8 B pixels correspond to the R, G, and B filters in the basic arrangement pattern, respectively. That is, the ratio of the R, G, and B pixels is 2:5:2 and the percentage of the G pixels having the highest contribution to obtaining the brightness signal is higher than the percentage of the R pixels and the percentage of the B pixels.

As described above, the percentage of the G pixels is different from the percentage of the R pixels and the percentage of the B pixels. In particular, the percentage of the G pixels having the highest contribution to obtaining the brightness signal is higher than the percentage of the R pixels and the percentage of the B pixels. Therefore, it is possible to suppress aliasing during the synchronization process and to improve high-frequency reproducibility.

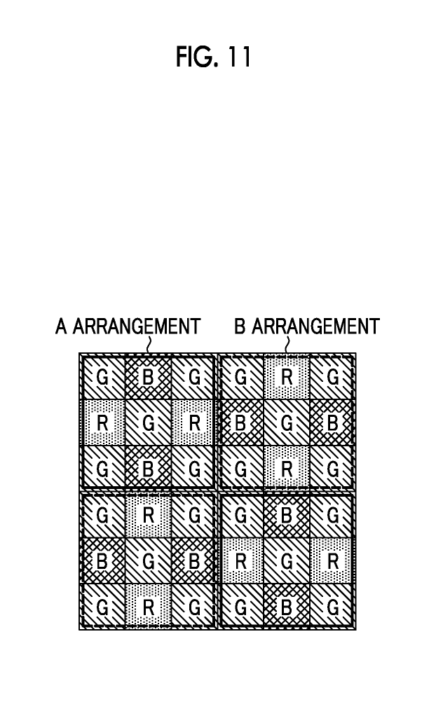

FIG. 11 illustrates a state in which the basic arrangement pattern P illustrated in FIG. 10 is divided into four regions each having 3×3 pixels.

As illustrated in FIG. 11, the basic arrangement pattern P is regarded as an arrangement in which an A arrangement of 3×3 pixels that is surrounded by a solid frame and a B arrangement of 3×3 pixels that is surrounded by a dashed frame are alternately arranged in the horizontal and vertical directions.

In each of the A arrangement and the B arrangement, the G filters are arranged at four corners and the center. That is, the G filters are arranged on both diagonal lines. In the A arrangement, the R filters are arranged in the horizontal direction, with the G filter interposed therebetween, and the B filters are arranged in the vertical direction, with the G filter interposed therebetween. In the B arrangement, the B filters are arranged in the horizontal direction, with the G filter interposed therebetween, and the R filters are arranged in the vertical direction, with the G filter interposed therebetween. That is, the A arrangement and the B arrangement are similar to each other except that the positions of the R filter and the B filter are reversed.

Since the A arrangement and the B arrangement are alternately arranged in the horizontal and vertical directions, the G filters which are arranged at four corners in the A arrangement and the B arrangement become G filters in a square arrangement corresponding to 2×2 pixels.

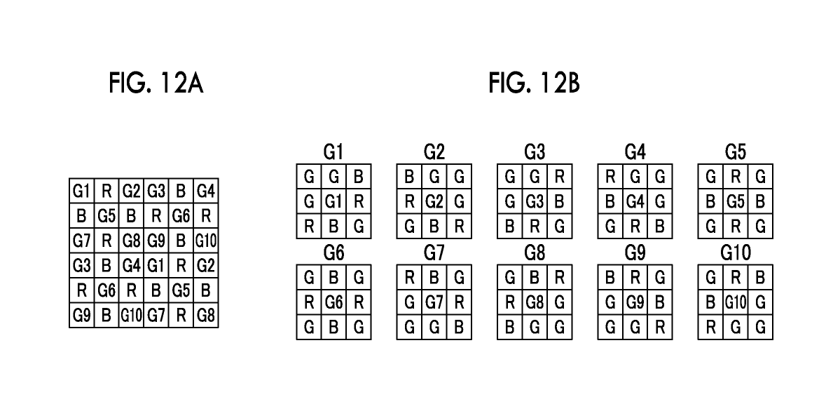

FIGS. 12A and 12B illustrates the types of first pixels in the new color filter arrangement illustrated in FIGS. 10 and 11. The new color filter arrangement illustrated in FIGS. 10 and 11 includes ten types of first pixels (see FIG. 12A). Specifically, the ten types of first pixels are as shown in FIG. 12B. That is, as illustrated in FIG. 12B, G, B, G, and R are arranged on the upper, lower, left, and right sides of G1, respectively. G, B, R, and G are arranged on the upper, lower, left, and right sides of G2, respectively. G, R, G, and B are arranged on the upper, lower, left, and right sides of G3, respectively. G, R, B, and G are arranged on the upper, lower, left, and right sides of G4, respectively. R, R, B, and B are arranged on the upper, lower, left, and right sides of G5, respectively. B, B, R, and R are arranged on the upper, lower, left, and right sides of G6, respectively. B, G, G, and R arranged on the upper, lower, left, and right sides of G7, respectively. B, G, R, and G are arranged on the upper, lower, left, and right sides of G8, respectively. R, G, G, and B are arranged on the upper, lower, left, and right sides of G9, respectively. R, G, B, and G are arranged on the upper, lower, left, and right sides of G10, respectively.

In the above description, the types of first pixels are classified by the arrangement of pixels which are adjacent to the first pixel at the minimum pixel pitch. However, the method for classifying the types of first pixels is not limited thereto. For example, when color mixture occurs due to a factor, such as the base structure of the imaging element 22, other than colors, the factor may be considered in the classification method.

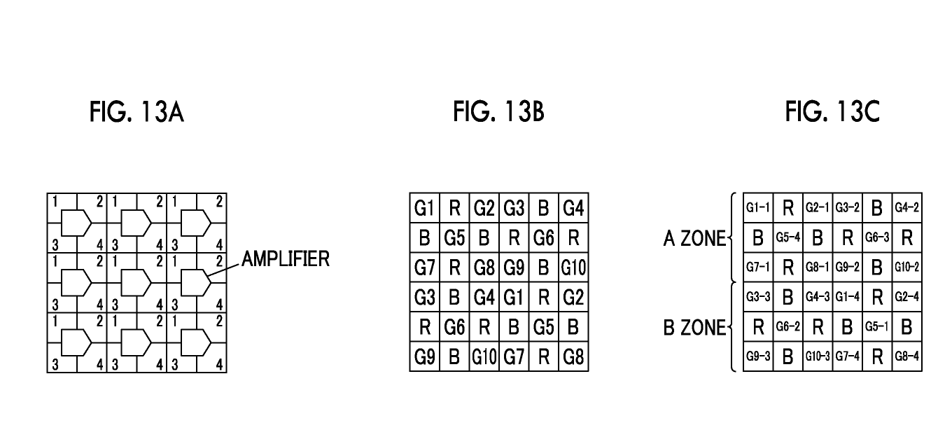

FIGS. 13A to 13C are diagrams illustrating a method of classifying the types of first pixels considering the base structure of the imaging element 22 in a 6×6 basic arrangement pattern of a new color filter arrangement.

FIG. 13A illustrates an example of the classification of the types when an amplifier is shared in the range of the 6×6 basic arrangement pattern of the new color filter arrangement.

For example, when pixels have the same first color and different bases, they are treated as different types of pixels. FIG. 13B illustrates the new color filter arrangement illustrated in FIG. 12A. In the new color filter arrangement, as described above, there are ten types of first pixels when the types of first pixels are classified by the arrangement of pixels which are adjacent at the minimum pixel pitch in four directions, that is, in the upper, lower, left, and right directions [a first direction (vertical direction) and a second direction (horizontal direction)]. FIG. 13C illustrates the classification of the types when the classification of the types by the sharing of the amplifier illustrated in FIG. 13A and the classification of the types by the arrangement of pixels, which are adjacent at the minimum pixel pitch, illustrated in FIG. 13B. As illustrated in FIG. 13C, in the 6×6 basic arrangement pattern, G1 to G10 are each arranged in an A zone and G1 to G10 are each arranged in a B zone. However, when the classification of the types by the sharing of the amplifier is considered as described in FIG. 13C, for example, G1 in the A zone becomes G1-1 and G1 in the B zone becomes G1-4, as illustrated in FIG. 13C. Therefore, G1s are regarded as different types of pixels.

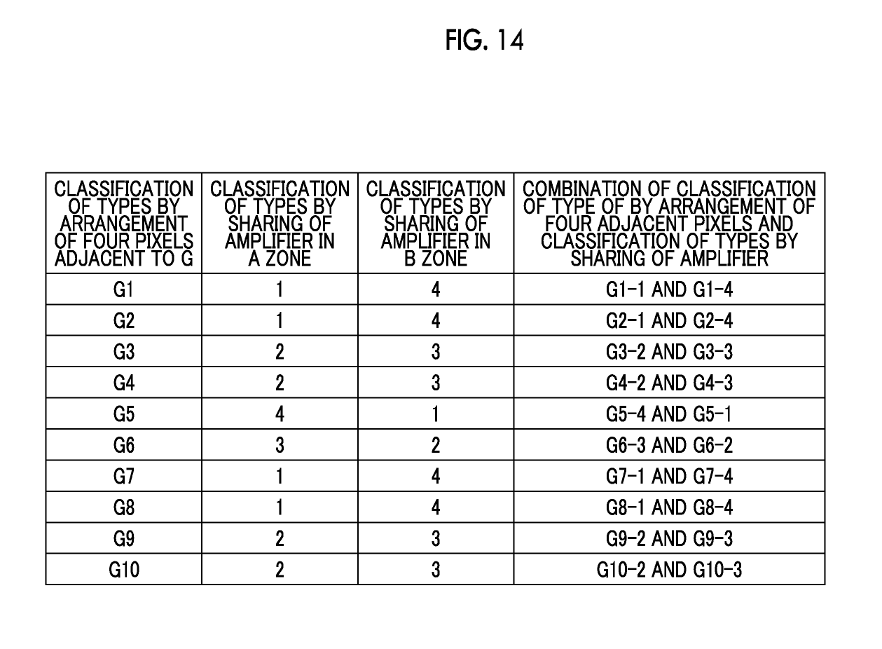

FIG. 14 illustrates the classification of the types illustrated in FIGS. 13A to 13C as a table. For example, G1 includes two types, that is, G1-1 ((the classification of the types by the arrangement of four adjacent pixels)-(the classification of the types by the sharing of the amplifier)) and G1-4. As illustrated in FIG. 14, G1 to G10 each includes two types, considering the classification of the types by the arrangement of four adjacent pixels and the classification of the types by the sharing of the amplifier. The basic arrangement pattern of a new color filter arrangement includes a total of 20 types.

In the invention, when the types of first pixels are classified considering the base structure of the imaging element 22, it is possible to suppress the generation of a false color in detail.

The meaning of the base structure is not limited to the classification of the types by the sharing of the amplifier, but may include various factors of the base structure.

In the invention, the mosaic image acquisition unit 106 (FIG. 3) performs the process of reducing the number of types of first pixels in the first embodiment and the mosaic image generation unit 108 (FIG. 5) performs the process in the second embodiment. Various processes are considered as the process of reducing the number of types of first pixels. For example, an extraction process is given as an example of the process of reducing the number of types of first pixels.

Next, an example in which a process is performed on a new color filter arrangement while appropriately changing an extraction rate will be described.

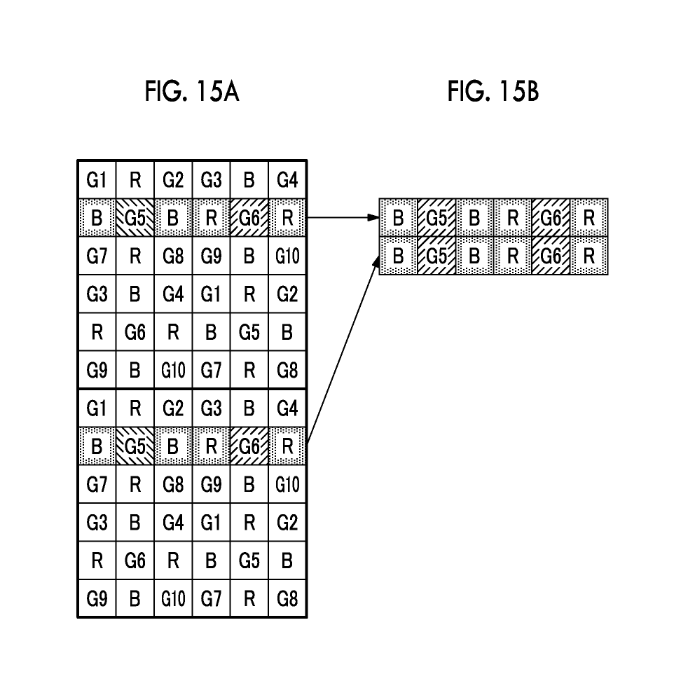

FIGS. 15A and 13B illustrate an aspect in which a ⅙ extraction process is performed on a new color filter arrangement. When a case in which the entire mosaic image (first mosaic image) is read from the imaging element 22 is considered, the first mosaic image illustrated in FIG. 15A has a 6×6 minimum unit and one column or one row of the basic arrangement pattern is regularly extracted from the 6×6 minimum unit (see arrows in FIGS. 15A and 15B). FIG. 15B illustrates a second mosaic image after the extraction process is performed. When an image is read from the imaging element 22, the entire image is not read, but a portion of the image may be extracted.

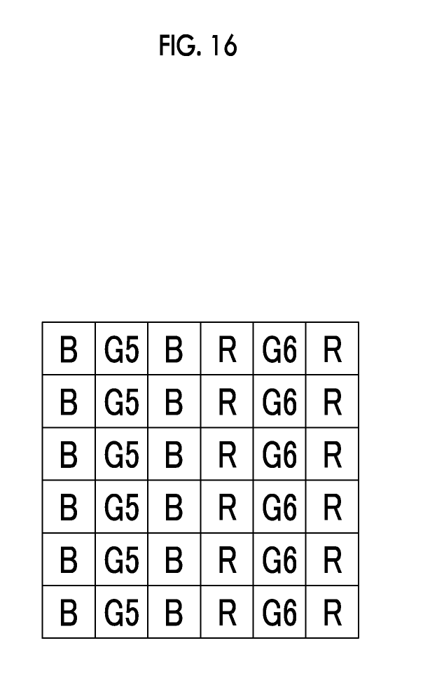

FIG. 16 illustrates the second mosaic image after the ⅙ extraction process illustrated in FIGS. 15A and 15B is performed. When the ⅙ extraction process is performed on the second mosaic image illustrated in FIG. 16, a single type of first pixels (in this case, G5 and G6) is arranged on a straight line extending in the first direction (vertical direction). Specifically, G5s are arranged on a straight line extending in the first direction (vertical direction) and G6s are arranged on a straight line extending in the first direction. The second mosaic image illustrated in FIG. 16 is very effective in suppressing a false signal (false color) caused by color mixture. The reason is as follows. The types considering the arrangement of pixels, which are adjacent to G of the first color having a high contribution ratio for obtaining the brightness signal, in four directions are two types, that is, G5 and G6 and the number of types of G is reduced. Therefore, it is easy to respond to the color mixture of G In addition, G5s and G6s are arranged on a straight line extending in the first direction (vertical direction). Therefore, when image quality deteriorates due to, for example, the false signal, it is easy to correct the image quality. Since the first pixels (in this case, Gs) and the second pixels (in this case, B and R) are arranged in the second direction (horizontal direction), this arrangement is effective in the synchronization process.

The term “single type” means one type of first pixels.

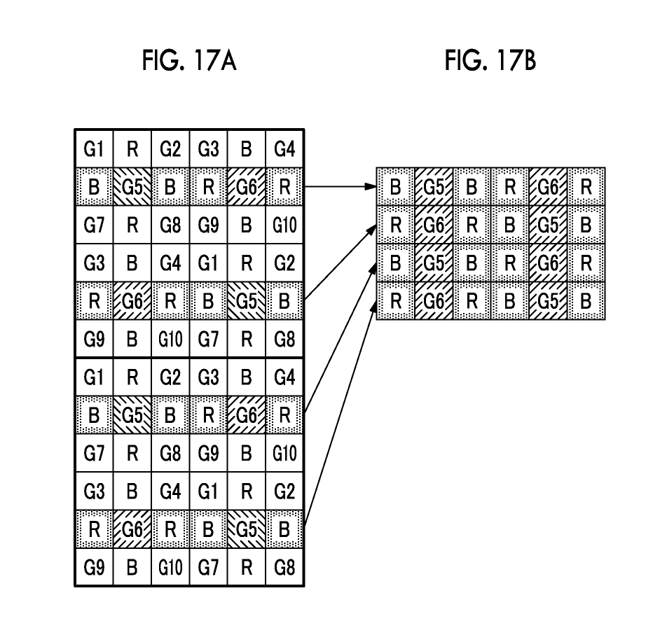

FIGS. 17A and 17B illustrate an aspect in which a 1/3 extraction process is performed on a new color filter arrangement. When a case in which the entire mosaic image (first mosaic image) is read from the imaging element 22, the first mosaic image illustrated in FIG. 17A has a 6×6 minimum unit and two columns of the basic arrangement pattern are regularly extracted from the 6×6 minimum unit (see arrows in FIGS. 17A and 17B). FIG. 17B illustrates a second mosaic image after the extraction process is performed. When an image is read from the imaging element 22, the entire image is not read, but a portion of the image may be extracted.

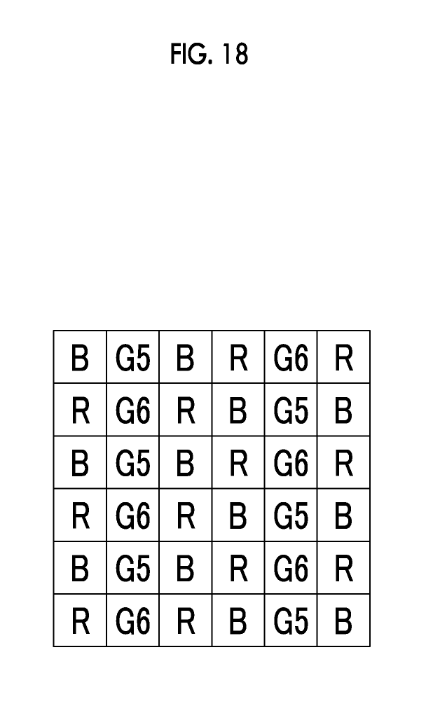

FIG. 18 illustrates the second mosaic image after the ⅓ extraction process illustrated in FIGS. 17A and 17B is performed. In the second mosaic image illustrated in FIG. 18, the first pixels (in this case, G5 and G6) are arranged on a straight line extending in the first direction (vertical direction) while the types of first pixels have regularity (in this case, G5 and G6 are alternately arranged). In addition, the term “having regularity” means that the types of first pixels are arranged in a given order, for example, several types of first pixels are repeated according to a given rule.

The second mosaic image illustrated in FIG. 18 is very effective in suppressing a false signal (false color) caused by color mixture. The reason is as follows. The types considering the arrangement of pixels, which are adjacent to G of the first color having a high contribution ratio for obtaining the brightness signal, in four directions are two types, that is, G5 and G6 and the number of types of G is reduced. Therefore, it is easy to respond to the color mixture of G.

In addition, G5s and G6s are arranged on a straight line extending in the first direction (vertical direction). Therefore, when image quality deteriorates due to, for example, the false signal, it is easy to correct the image quality. Since the first pixels (in this case, Gs) and the second pixels (in this case, B and R) are arranged in the second direction (horizontal direction) (in this case, the horizontal direction), it is easy to perform an interpolation process in the synchronization process.

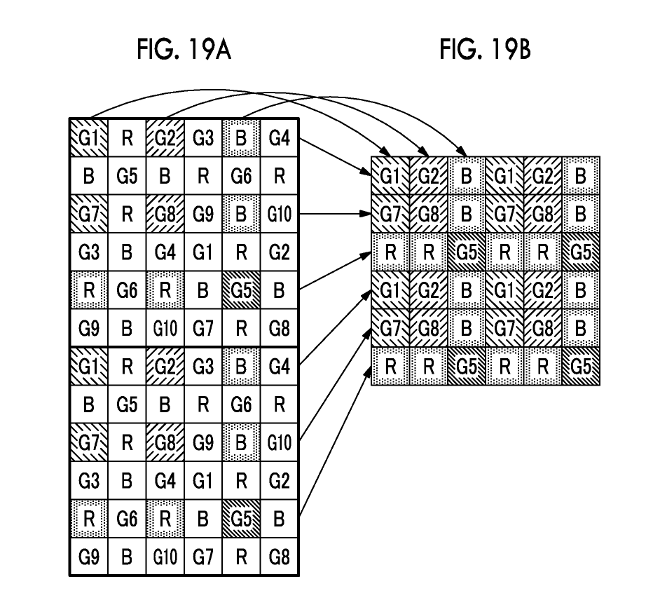

FIGS. 19A and 19B illustrate an aspect in which a ½ extraction process is performed in the first direction (vertical direction) and the second direction (horizontal direction) (the vertical and horizontal directions in FIGS. 19A and 19B) in a new color filter arrangement (the first, third, and fifth columns and the first, third, and fifth rows of the basic arrangement pattern are extracted). When a case in which the entire mosaic image (first mosaic image) is read from the memory unit 26 is considered, the first mosaic image illustrated in FIG. 19A has a 6×6 minimum unit and an extraction process of regularly extracting three columns and three rows from the 6×6 minimum unit is performed (see arrows in FIGS. 19A and 19B). FIG. 19B illustrates a second mosaic image after the extraction process is performed. When an image is read from the imaging element 22, the entire image is not read, but a portion of the image may be extracted.

The second mosaic image illustrated in FIG. 19B is very effective when a high-resolution image quality is required. This is because the ½ extraction process can obtain a higher resolution image than the ⅓ extraction process and the ⅙ extraction process. In FIG. 19B, the number of types of first pixels is 5, which is smaller than ten types of first pixels in the first mosaic image and it is easy to correct color mixture correction or to correct deterioration of image quality.

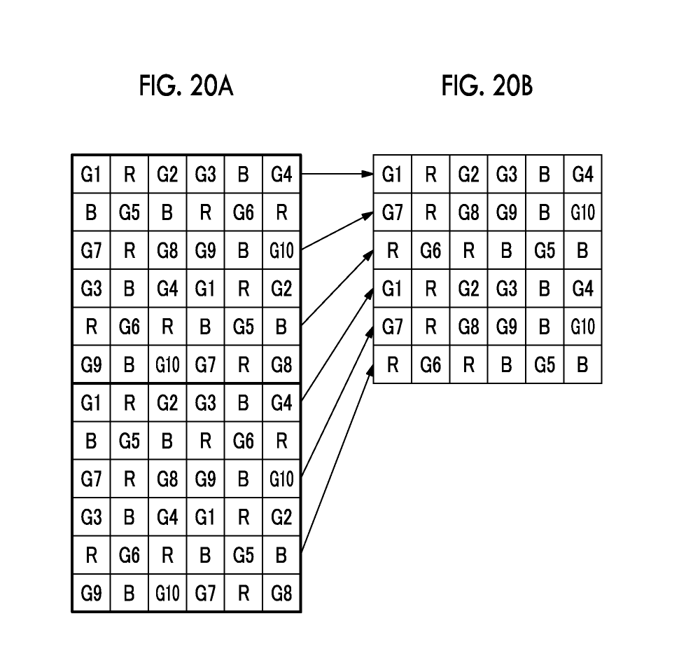

FIGS. 20A and 20B illustrate the second image filter obtained by performing the ½ extraction process in the second direction (horizontal direction) in a new color filter arrangement. When a case in which the entire mosaic image (first mosaic image) is read from the imaging element 22 is considered, the first mosaic image illustrated in FIG. 20A has a 6×6 minimum unit and the ½ extraction process is regularly performed on the 6×6 minimum unit (the first, third, and fifth rows of the basic arrangement pattern are extracted) (see arrows in FIGS. 20A and 20B). FIG. 20B illustrates a second mosaic image after the extraction process is performed.

In the second mosaic image illustrated in FIG. 20B, G1, G7, and R are regularly arranged in the first direction (vertical direction) and all lines in the second direction (horizontal direction) have R, G, and B colors. In this case, in the second mosaic image, since the number of types of first pixels is 10, the color mixture correction process is complicated. Therefore, when the color mixture information is not identified, it is not easy to correct deterioration of image quality due to color mixture. However, when the color mixture information (the amount of color mixture or the color mixture ratio) is identified, it is possible to perform the color mixture correction process. In addition, since the ½ extraction process is performed, it is possible to obtain a high-resolution image, as compared to the ⅓ extraction process and the ⅙ extraction process.

In the invention, it is preferable to appropriately change the extraction rate. The extraction rate is appropriately changed to obtain an image with a desired resolution.

Next, an example in which the number of types of first pixels is appropriately changed in the first mosaic image and then the extraction process is performed will be described.

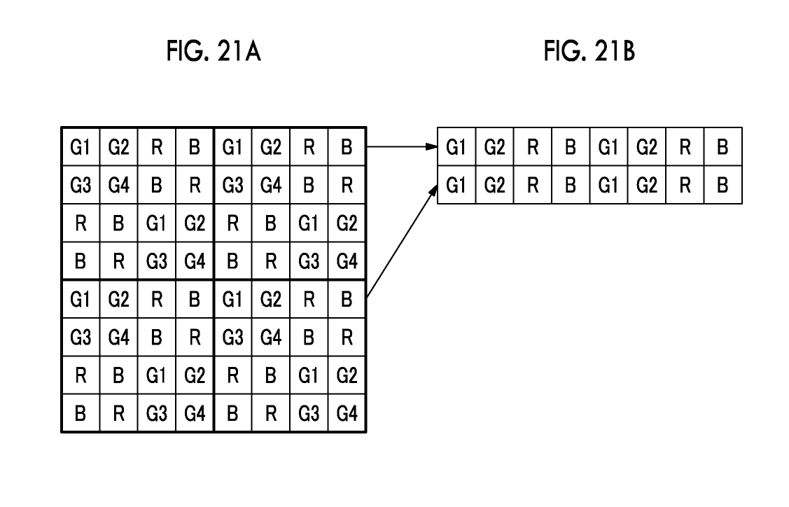

FIGS. 21A and 21B illustrate an example of the color filter arrangement in which the number of types of first pixels is 4 in the first mosaic image. As illustrated in FIG. 21A, B, G, B, and G are arranged on the upper, lower, left, and right sides of G1, respectively. R, G, G, and R are arranged on the upper, lower, left, and right sides of G2, respectively. G, R, R, and G are arranged on the upper, lower, left, and right sides of G3, respectively. G, B, G, and B are arranged on the upper, lower, left, and right sides of G4, respectively. In the first mosaic image illustrated in FIG. 21A in which the number of types of first pixels is 4, when a ¼ extraction process is performed starting from a line including G1 (see arrows in FIGS. 21A and 21B), it is possible to obtain a mosaic image illustrated in FIG. 21B in which the number of types of first pixels is reduced to 2.

In FIG. 21B, G1, G2, R, and B are arranged on a straight line extending in the first direction (vertical direction). In addition, there is a line including G1, G2, R, and B on the straight line extending in the second direction (horizontal direction). Since there is a single type of line in the vertical direction, color mixture correction is simplified. In addition, since there are lines including G1, G2, R, and B in the horizontal direction, the accuracy of interpolation is improved.

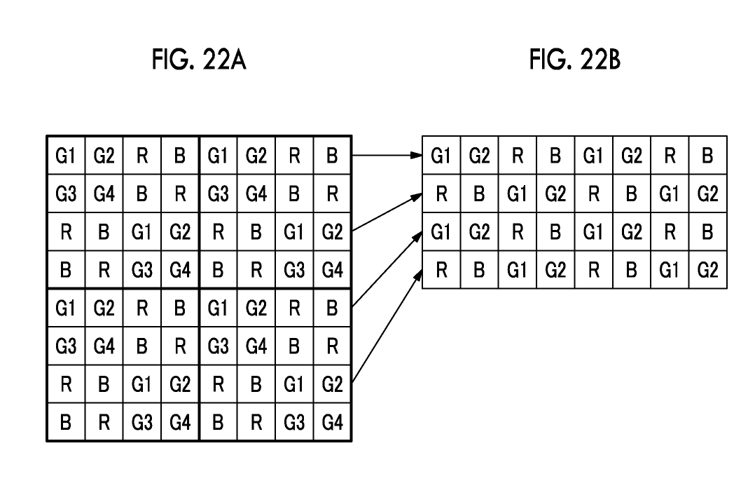

FIGS. 22A and 22B illustrate an example of a color filter arrangement in which the number of types of first pixels is 4 in the first mosaic image illustrated in FIGS. 21A and 21B. In this example, the extraction rate is changed from ¼ to ½. As a result, a mosaic image in which the number of types of first pixels is reduced to 2 is obtained. The obtained mosaic image includes a line including G1 and R and a line including G2 and B in the first direction (vertical direction) and includes a line including G1, G2, R, and B on a straight line extending in the second direction (horizontal direction). Therefore, the accuracy of interpolation is improved.

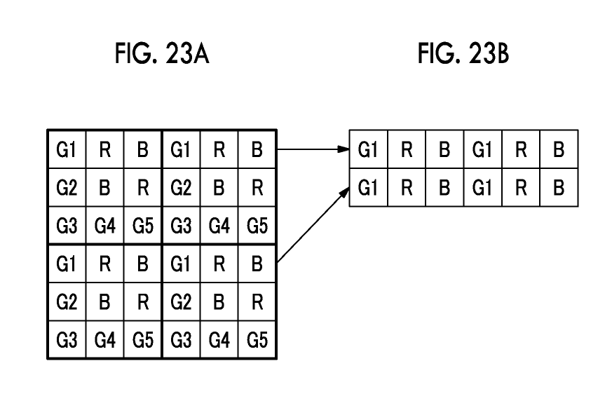

FIGS. 23A and 23B illustrate an example of a color filter arrangement in which the number of types of first pixels is 5 in the first mosaic image. As illustrated in FIG. 23A, G, G, B, and R are arranged on the upper, lower, left, and right sides of G1, respectively. G, G, R, and B are arranged on the upper, lower, left, and right sides of G2, respectively. G, G, G, and G are arranged on the upper, lower, left, and right sides of G3, respectively. B, R, G, and G are arranged on the upper, lower, left, and right sides of G4, respectively. R, B, G, and G are arranged on the upper, lower, left, and right sides of G5, respectively. In the first mosaic image illustrated in FIG. 23A in which the number of types of first pixels is 5, when the ⅓ extraction process is performed starting from a line including G1 (see arrows in FIGS. 23A and 23B), it is possible to obtain the mosaic image illustrated in FIG. 23B in which the number of types of first pixels is reduced to 2.

In FIG. 23B, G1, R, and B are arranged on a straight line extending in the first direction (vertical direction). In addition, there is a line including G1, R, and B on the straight line extending in the second direction (horizontal direction). Therefore, since there is a single type of line in the vertical direction, color mixture correction is simplified. In addition, since there is a line including G1, G2, R, and B in the horizontal direction, the accuracy of interpolation is improved.

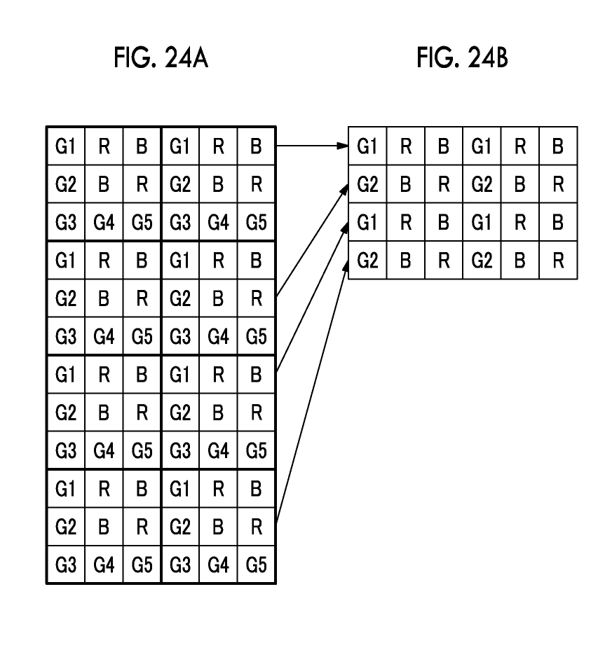

FIGS. 24A and 24B illustrate an example of a color filter arrangement in which the number of types of first pixels is 5 in the first mosaic image illustrated in FIGS. 23A and 23B. The extraction process alternately extracts a line including G1 and a line including G2 (see arrows in FIGS. 24A and 24B). A mosaic image in which the number of types of first pixels is reduced to 2 is obtained by the extraction process. The obtained mosaic image includes a line including G1 and G2 and a line including R and B in the first direction (vertical direction) and includes a line including G1, B, and R and a line including G2, B, and R on the straight lines extending in the second direction (horizontal direction). Therefore, the accuracy of interpolation is improved.

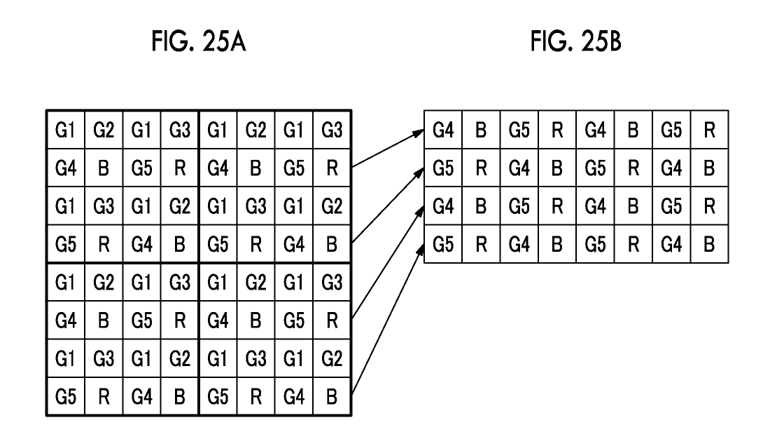

FIGS. 25A and 25B illustrate an example of a color filter arrangement in which the number of types of first pixels is 5 in the first mosaic image. As illustrated in FIG. 25A, G, G, G, and G are arranged on the upper, lower, left, and right sides of G1, respectively. R, B, G, and G are arranged on the upper, lower, left, and right sides of G2, respectively. B, R, G, and G are arranged on the upper, lower, left, and right sides of G3, respectively. G, G, R, and B are arranged on the upper, lower, left, and right sides of G4, respectively. G, G, B, and R are arranged on the upper, lower, left, and right sides of G5, respectively. In the first mosaic image illustrated in FIG. 25A in which the number of types of first pixels is 5, when the ½ extraction process is performed starting from a line including G4 (see arrows in FIGS. 25A and 25B), it is possible to obtain a mosaic image illustrated in FIG. 25B in which the number of types of first pixels is reduced to 2.

In FIG. 25B, G4 and G5 are alternately arranged on a straight line extending in the first direction (vertical direction) and R and B are alternately arranged on a straight line extending in the first direction. In addition, there is a line including G4, G5, R, and B on a straight line extending in the second direction (horizontal direction). Therefore, since there is a single type of line in the vertical direction, color mixture correction is simplified. In addition, since there is a line including G4, G5, R, and B in the horizontal direction, the accuracy of interpolation is improved.

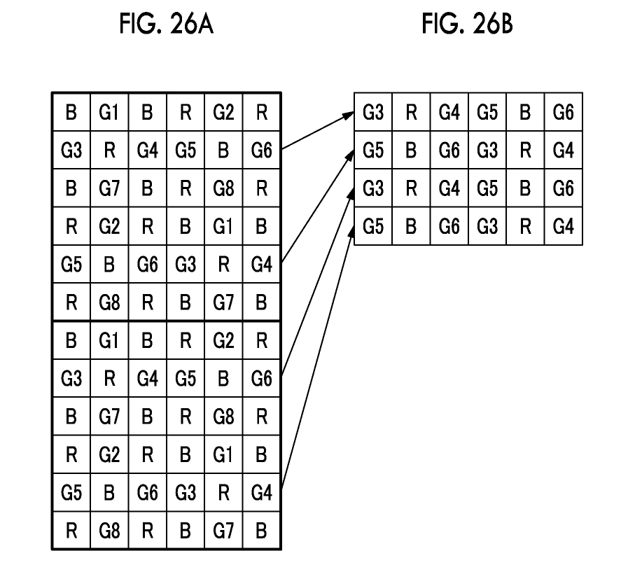

FIGS. 26A and 26B illustrate an example of a color filter arrangement in which the number of types of first pixels is 8 in the first mosaic image. As illustrated in FIG. 26A, G, R, B, and B are arranged on the upper, lower, left, and right sides of G1, respectively. G, B, R, and R are arranged on the upper, lower, left, and right sides of G2, respectively. B, B, G, and R are arranged on the upper, lower, left, and right sides of G3, respectively. B, B, R, and G are arranged on the upper, lower, left, and right sides of G4, respectively. R, R, G, and B are arranged on the upper, lower, left, and right sides of G5, respectively. R, R, B, and G are arranged on the upper, lower, left, and right sides of G6, respectively. R, G, B, and B are arranged on the upper, lower, left, and right sides of G7, respectively. B, G, R, and R are arranged on the upper, lower, left, and right sides of G8, respectively. In the first mosaic image illustrated in FIG. 26A in which the number of types of first pixels is 8, when the ⅓ extraction process is performed starting from a line including G3 (see arrows in FIGS. 26A and 26B), it is possible to obtain a mosaic image illustrated in FIG. 26B in which the number of types of first pixels is reduced to 4.

In FIG. 26B, G3 and G5 are alternately arranged on a straight line extending in the first direction (vertical direction), R and B are alternately arranged on a straight line extending in the first direction, and G4 and G6 are alternately arranged on a straight line extending in the first direction. In addition, there is a line including G3, G4, G5, G6, R, and B on a straight line extending in the second direction (horizontal direction). Therefore, since there is a line including G3, G4, G5, G6, R, and B in the horizontal direction, the accuracy of interpolation is improved.

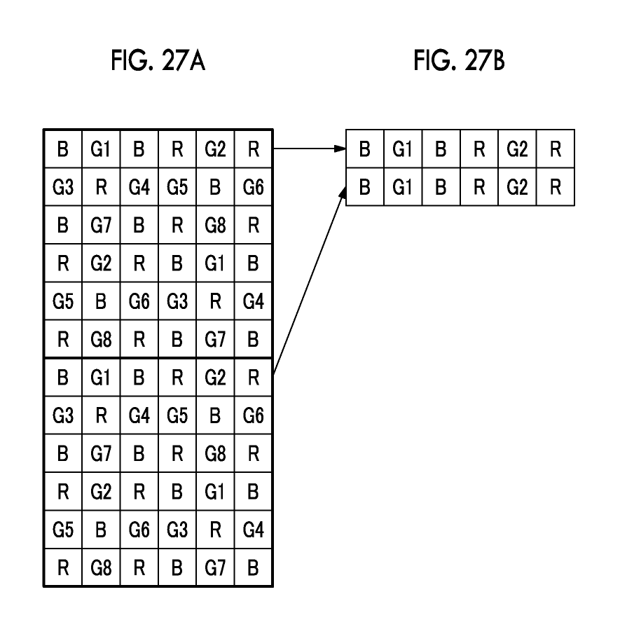

FIGS. 27A and 27B illustrate an example of a color filter arrangement in which the number of types of first pixels is 8 in the first mosaic image illustrated in FIG. 26A. A line including G1 and G2 is extracted (see arrows in FIGS. 27A and 27B). A mosaic image in which the number of types of first pixels is reduced to 2 is obtained by the extraction process. In the obtained mosaic image, each of G1, G2, R, and B is arranged as a single type in a straight line in the first direction (vertical direction) and there is a line including G1, G2, B, and R on a straight line extending in the second direction (horizontal direction). Therefore, the accuracy of interpolation is improved.

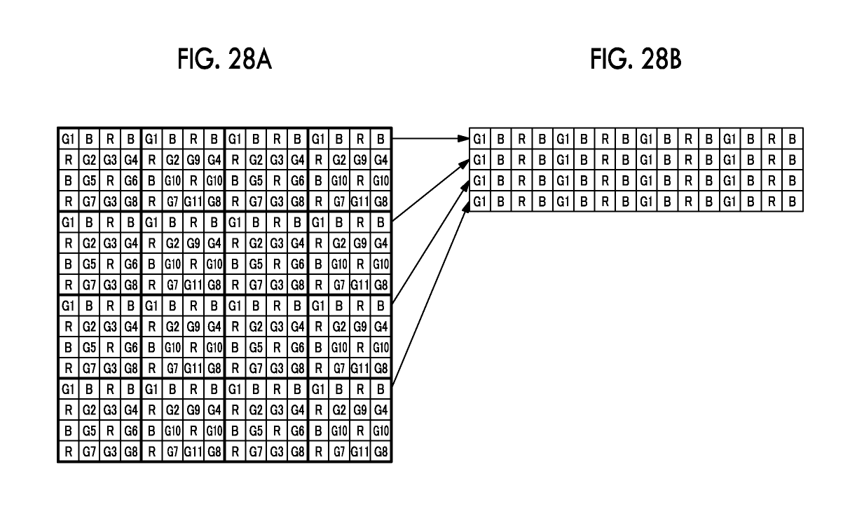

FIGS. 28A and 28B illustrate an example of a color filter arrangement in which the number of types of first pixels is 11 in the first mosaic image. As illustrated in FIG. 28A, R, R, B, and B are arranged on the upper, lower, left, and right sides of G1, respectively. B, G, R, and G are arranged on the upper, lower, left, and right sides of G2, respectively. R, R, G, and G are arranged on the upper, lower, left, and right sides of G3, respectively. B, G, G, and R are arranged on the upper, lower, left, and right sides of G4, respectively. G, G, B, and R are arranged on the upper, lower, left, and right sides of G5, respectively. G, G, R, and B are arranged on the upper, lower, left, and right sides of G6, respectively. G, B, R, and G are arranged on the upper, lower, left, and right sides of G7, respectively. G, B, G, and R are arranged on the upper, lower, left, and right sides of G8, respectively. R, R, G, and G are arranged on the upper, lower, left, and right sides of G9, respectively. G, G, B, and B are arranged on the upper, lower, left, and right sides of G10, respectively. B, R, G, and G are arranged on the upper, lower, left, and right sides of G11, respectively. In the first mosaic image illustrated in FIG. 26A in which the number of types of first pixels is 11, when the ¼ extraction process is performed starting from a line including G1 (see arrows in FIGS. 28A and 28B), it is possible to obtain a mosaic image illustrated in FIG. 28B in which the number of types of first pixels is reduced to 2.

In FIG. 28B, each of G1, R, and B is arranged on a straight line extending in the first direction (vertical direction). There is a line including G1, G2, R, and B on a straight line extending in the second direction (horizontal direction). Since there is a line including G1, G2, R, and B in the horizontal direction, the accuracy of interpolation is improved.

An imaging apparatus 10 according to another aspect of the invention includes the above-mentioned image processing device and lens-interchangeable imaging unit including an imaging optical system and an imaging element on which an object image is formed through the imaging optical system. Since the imaging apparatus 10 having the lens-interchangeable imaging means includes the above-mentioned image processing device, it is possible to suppress a false color caused by color mixture.

According to the invention, there is provided an image processing method that generates three-layer color data on the basis of a first mosaic image obtained from a single color imaging element in which color filters are provided in a predetermined color filter arrangement on a plurality of pixels that are two-dimensionally arranged. The image processing method includes: a lens information acquisition step of acquiring information of a lens which is used to capture an image; a color mixture information determination step of determining whether color mixture information used for color mixture correction is identified or unidentified on the basis of the lens information; a mosaic image acquisition step of, when the color mixture information is determined to be unidentified in the color mixture information determination step, reading, from the color imaging element, a second mosaic image obtained by reducing the number of types of first pixels in the first mosaic image which includes a pixel of a first color formed by at least one color and a pixel of a second color formed by at least two colors other than the first color and in which the number of types of first pixels determined by the arrangement of pixels that are adjacent to a first pixel, which is the pixel of the first color, at a minimum pixel pitch in four directions is equal to or greater than 4, and when the color mixture information is determined to be identified in the color mixture information determination step, reading the first mosaic image from the color imaging element; a color mixture correction step of performing the color mixture correction for the first mosaic image when the color mixture information is determined to be identified in the color mixture information determination step; and a synchronization step of generating colors of three layers from the first mosaic image subjected to the color mixture correction or the second mosaic image. The first color is formed by a color having a higher contribution ratio for obtaining a brightness signal than the second color. According to the image processing method of the invention, even when the amount of color mixture is unidentified, it is possible to suppress deterioration of image quality due to a false signal. Even when a complex color filter arrangement is used, it is possible to reliably simply perform color mixture correction for a mosaic image.

The invention is particularly effective in performing image processing on a moving image or a through image (live view image). However, the invention is not particularly limited thereto.

The invention is more effective in a mosaic image (color filter arrangement) in which the number of types of first pixels is equal to or greater than 4, preferably, 5, and more preferably, 6 and is equal to or less than 12, preferably, 11, and more preferably 10 in the first mosaic image.

The digital camera has been described as an embodiment of the imaging apparatus according to the invention. However, the structure of the imaging apparatus is not limited to the digital camera. For example, an embedded or external PC camera or a mobile terminal apparatus with an imaging function, which will be described below, can be used as another imaging apparatus according to the invention.

Examples of a mobile terminal apparatus, which is an embodiment of the imaging apparatus according to the invention, include mobile phones, smart phones, personal digital assistants (PDA), and portable game machines. Next, a smart phone will be described in detail as an example of the imaging apparatus, with reference to the drawings.

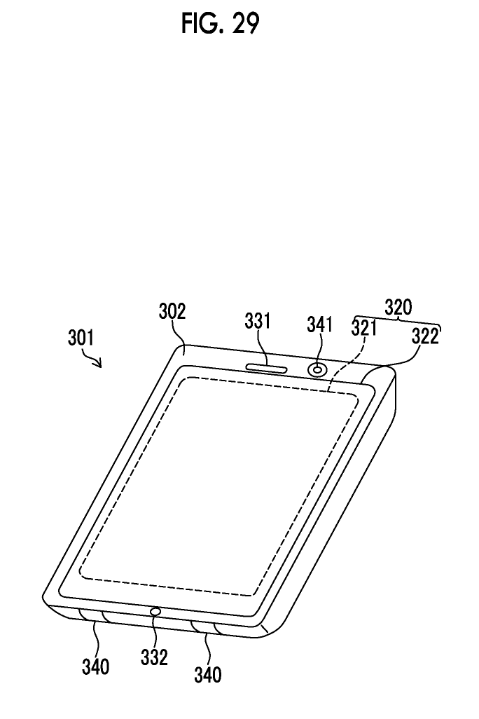

FIG. 29 illustrates the outward appearance of a smart phone 301 which is an embodiment of the imaging apparatus according to the invention. The smart phone 301 illustrated in FIG. 29 includes a housing 302 having a flat plate shape and a display input unit 320 in which a display panel 321 that is provided as a display unit on one surface of the housing 302 and an operation panel 322 as an input unit are integrated with each other. The housing 302 includes a speaker 331, a microphone 332, an operation unit 340, and a camera unit 341. The structure of the housing 302 is not limited to the above-mentioned structure. For example, the housing 302 may have a structure in which the display unit and the input unit are independent of each other, a structure in which the display unit and the input unit overlap each other, or a structure including a slide mechanism.

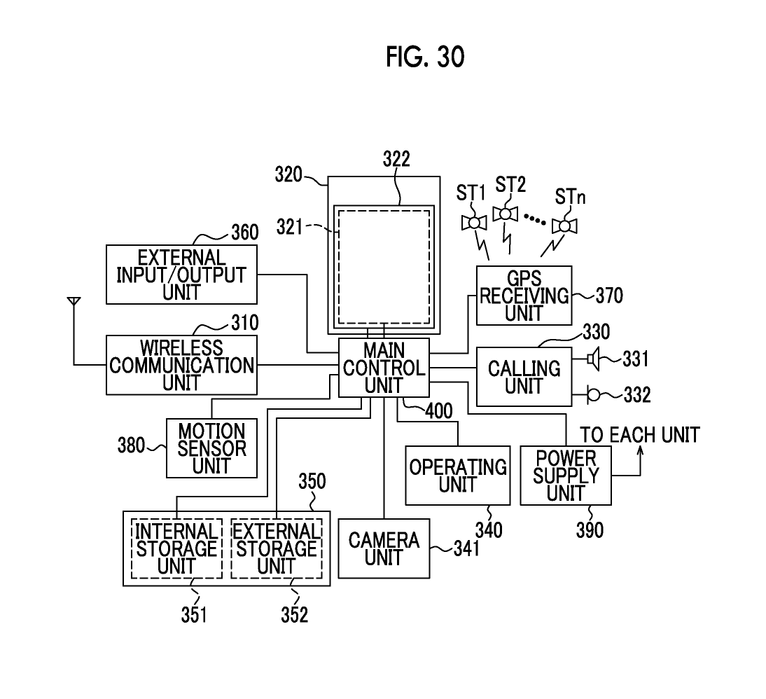

FIG. 30 is a block diagram illustrating the structure of the smart phone 301 illustrated in FIG. 29. As illustrated in FIG. 30, the smart phone includes, as main components, a wireless communication unit 310, the display input unit 320, a calling unit 330, the operation unit 340, the camera unit 341, a storage unit 350, an external input/output unit 360, a global positioning system (GPS) receiving unit 370, a motion sensor unit 380, a power supply unit 390, and a main control unit 400. In addition, the smart phone 301 has, as a main function, a wireless communication function of performing mobile radio communication with a base station apparatus BS through a mobile communication network NW.

The wireless communication unit 310 performs wireless communication with the base station apparatus BS belonging to the mobile communication network NW in response to an instruction from a main control unit 400. The wireless communication unit 310 transmits and receives, for example, various types of file data, such as audio data and image data, and electronic mail data or receives, for example, Web data or streaming data, using the wireless communication.

The display input unit 320 is a so-called touch panel that displays, for example, images (still images and moving images) or textual information to visually transmit information to the user and detects the operation of the user for the displayed information, under the control of the main control unit 400, and includes a display panel 321 and an operation panel 322.

The display panel 321 uses, for example, a liquid crystal display (LCD) or an organic electro-luminescence display (OELD) as a display device. The operation panel 322 is a device that is mounted such that an image displayed on a display screen of the display panel 321 can be visually recognized, is operated by the finger of the user or a stylus, or detects a plurality of coordinates. When the device is operated by the finger of the user or the stylus, it outputs a detection signal which is generated by the operation to the main control unit 400. Then, the main control unit 400 detects an operation position (coordinates) on the display panel 321 on the basis of the received detection signal.

As illustrated in FIG. 29, the display panel 321 and the operation panel 322 of the smart phone 301 which is given as an embodiment of the imaging apparatus according to the invention are integrated with each other to form the display input unit 320 and the operation panel 322 is arranged so as to cover the entire display panel 321. When this arrangement is used, the operation panel 322 may have a function of detecting the operation of the user even in a region outside the display panel 321. In other words, the operation panel 322 may include a detection region (hereinafter, referred to as a display region) for a portion which overlaps the display panel 321 and a detection region (hereinafter, referred to as a non-display region) for an edge portion which does not overlap the display panel 321.

The size of the display region may be completely equal to the size of the display panel 321. However, the sizes are not necessarily equal to each other. In addition, the operation panel 322 may include two sensitive regions, that is, an edge portion and an inner portion other than the edge portion. The width of the edge portion is appropriately designed depending on, for example, the size of the housing 302. For example, any of a matrix switching method, a resistive film method, a surface acoustic wave method, an infrared method, an electromagnetic induction method, and a capacitance method may be used as a position detection method of the operation panel 322.

The calling unit 330 includes the speaker 331 and the microphone 332. The calling unit 330 converts the voice of the user which is input through the microphone 332 into voice data which can be processed by the main control unit 400 and outputs the voice data to the main control unit 400, or it decodes the voice data which is received by the wireless communication unit 310 or the external input/output unit 360 and outputs the decoded data from the speaker 331. As illustrated in FIG. 29, for example, the speaker 331 may be provided on the same surface as the display input unit 320 and the microphone 332 may be provided on the side surface of the housing 302.

The operation unit 340 is a hardware key using, for example, a key switch and receives instructions from the user. For example, as illustrated in FIG. 29, the operation unit 340 is a push-button-type switch that is provided on the side surface of the housing 302 of the smart phone 301, is turned on when it is pushed by, for example, the finger, and is turned off by the restoring force of, for example, a spring when the finger is removed.

The storage unit 350 stores control programs or control data of the main control unit 400, application software, address data associated with, for example, the names or phone numbers of communication partners, data for the transmitted and received electronic mail, Web data downloaded by Web browsing, or downloaded content data. In addition, the storage unit 350 temporarily stores, for example, streaming data. The storage unit 350 includes an internal storage unit 351 that is provided in the smart phone and a detachable external storage unit 352 having an external memory slot. The internal storage unit 351 and the external storage unit 352 of the storage unit 350 are implemented by storage media, such as a memory (for example, a MicroSD (registered trademark) memory) of, for example, a flash memory type, a hard disk type, a multimedia card micro type, or a card type, a random access memory (RAM), and a read only memory (ROM).

The external input/output unit 360 serves as an interface with all external apparatus connected to the smart phone 301 and is used to be directly or indirectly connected to other external apparatuses by communication (for example, a universal serial bus (USB) or IEEE1394) or a network (for example, Internet, a wireless LAN, or Bluetooth (registered trademark), radio frequency identification (RFID), Infrared Data Association (IrDA) (registered trademark), Ultra Wideband (UWB) (registered trademark), or ZigBee (registered trademark)).

Examples of the external apparatus connected to the smart phone 301 include wired/wireless headsets, wired/wireless external chargers, wired/wireless data ports, memory cards, subscriber identity module (SIM) cards, and user identity module (UIM) cards which are connected through card sockets, external audio/video apparatuses which are connected through audio and video input/output (I/O) terminals, external audio and video apparatuses which are wirelessly connected, smart phones which are connected wirelessly and by wire, personal computers which are connected wirelessly and by wire, PDAs which are connected wirelessly and by wire, personal computers which are connected wirelessly and by wire, and earphones. The external input/output unit can transmit data which is received from the external apparatuses to each internal component of the smart phone 301, or it can transmit the internal data of the smart phone 301 to the external apparatuses.

The GPS receiving unit 370 receives GPS signals which are transmitted from GPS satellites ST1 to STn, performs a positioning process on the basis of a plurality of received GPS signals, and detects the position of the smart phone 301 including latitude, longitude, and altitude, in response to instructions from the main control unit 400. When positional information can be acquired from the wireless communication unit 310 or the external input/output unit 360 (for example, a wireless LAN), the GPS receiving unit 370 can detect the position using the positional information.

The motion sensor unit 380 includes, for example, a triaxial acceleration sensor and can detect the physical movement of the smart phone 301 in response to instructions from the main control unit 400. The moving direction or acceleration of the smart phone 301 is detected from the detected physical movement of the smart phone 301. The detection result is output to the main control unit 400.

The power supply unit 390 supplies power which is stored in a battery (not illustrated) to each unit of the smart phone 301, in response to instructions from the main control unit 400.

The main control unit 400 includes a microprocessor and operates on the basis of the control program or control data stored in the storage unit 350 to control the overall operation of each unit of the smart phone 301. The main control unit 400 has an application processing function and a mobile communication control function of controlling each unit of a communication system in order to perform voice communication or data communication through the wireless communication unit 310.

The main control unit 400 operates on the basis of the application software stored in the storage unit 350 to implement the application processing function. Examples of the application processing function include an infrared communication function of controlling the external input/output unit 360 to perform data communication with an opposite apparatus, an electronic mail function of transmitting and receiving electronic mail, and a Web browsing function of browsing Web pages.

In addition, the main control unit 400 has an image processing function of displaying a video on the display input unit 320 on the basis of image data (still image or moving image data), such as received data or downloaded streaming data. The image processing function means a function of the main control unit 400 which decodes the image data, performs image processing on the basis of the decoding result, and displays an image on the display input unit 320.

The main control unit 400 performs display control for the display panel 321 and operation detection control for detecting the operation of the user through the operation unit 340 and the operation panel 322.

The main control unit 400 performs the display control to display a software key, such as an icon for starting application software or a scroll bar, or a window for creating electronic mail. The scroll bar means a software key for receiving an instruction to move a display portion of a large image which cannot be accommodated in a display region of the display panel 321.

The main control unit 400 performs the operation detection control to detect the operation of the user through the operation unit 340, to receive an operation for the icon or the input of a character string to an input field of the window through the operation panel 322, or to receive a scroll request for the display image through the scroll bar.

The main control unit 400 performs the operation detection control to determine whether an operation position on the operation panel 322 is an overlap portion (display region) which overlaps the display panel 321 or an edge portion (non-display region) which does not overlap the display panel 321 and has a touch panel control function of controlling a sensitive region of the operation panel 322 or a display position of the software key.

In addition, the main control unit 400 can detect a gesture operation for the operation panel 322 and perform a predetermined function according to the detected gesture operation. The gesture operation is not a simple touch operation according to the related art, but means an operation of drawing a locus with, for example, the finger, an operation of designating a plurality of positions at the same time, or a combination of the operations, that is, an operation of drawing the locus of at least one of a plurality of positions.

The camera unit 341 is a digital camera that performs an electronic imaging operation using an imaging element such as a complementary metal oxide semiconductor (CMOS) image sensor or a charge-coupled device (CCD) image sensor. In addition, the camera unit 341 can convert image data obtained by imaging into image data compressed by Joint Photographic Coding Experts Group (JPEG) and store the converted image data in the storage unit 350 or output the converted image data to the input/output unit 360 or the wireless communication unit 310, under the control of the main control unit 400. In the smart phone 301 illustrated in FIG. 29, the camera unit 341 is mounted on the same surface as the display input unit 320. However, the mounting position of the camera unit 341 is not limited thereto, but the camera unit 341 may be mounted on the rear surface of the display input unit 320 or a plurality of camera units 341 may be mounted. When the plurality of camera units 341 are mounted, the camera unit 341 to be used for imaging can be switched to independently capture images or the plurality of camera units 341 can be used at the same time to capture images.

The camera unit 341 can be used for various functions of the smart phone 301. For example, the image captured by the camera unit 341 can be displayed on the display panel 321 or the image of the camera unit 341 can be used as one of the operation inputs of the operation panel 322. In addition, when the GPS receiving unit 370 detects a position, it can detect the position with reference to the image from the camera unit 341. It is possible to determine the optical axis direction of the camera unit 341 of the smart phone 301 or the current usage environment with reference to the image from the camera unit 341, without using a triaxial acceleration sensor, or using the triaxial acceleration sensor and the image from the camera unit 341. Of course, the image from the camera unit 341 can be used in the application software.

In addition, for example, positional information acquired by the GPS receiving unit 370, voice information acquired by the microphone 332 (the main control unit may perform voice/text conversion to convert the voice information into text information), and posture information acquired by the motion sensor unit 380 may be added to image data for a still image or a moving image and the image data may be stored in the storage unit 350 or may be transmitted through the input/output unit 360 or the wireless communication unit 310.

The invention is not limited to the above-described embodiments and various modifications and changes of the invention can be made without departing from the scope and spirit of the invention.

What is claimed is:

1. An image processing device that generates three-layer color data on the basis of a first mosaic image obtained from a single color imaging element in which color filters are provided in a predetermined color filter arrangement on a plurality of pixels that are two-dimensionally arranged, comprising:
a lens information acquisition unit that acquires information of a lens which is used to capture an image;
a color mixture information determination unit that determines whether color mixture information used for color mixture correction is identified or unidentified on the basis of the lens information;
a mosaic image acquisition unit, when the color mixture information determination unit determines that the color mixture information is unidentified, that reads, from the color imaging element, a second mosaic image obtained by reducing the number of types of first pixels in the first mosaic image which includes a pixel of a first color formed by at least one color and a pixel of a second color formed by at least two colors other than the first color and in which the number of types of first pixels determined by the arrangement of pixels that are adjacent to a first pixel, which is the pixel of the first color, at a minimum pixel pitch in four directions is equal to or greater than 4, and when the color mixture information determination unit determines that the color mixture information is identified, that reads the first mosaic image from the color imaging element;
a color mixture correction unit that performs the color mixture correction for the first mosaic image when the color mixture information determination unit determines that the color mixture information is identified; and
a synchronization unit that generates colors of three layers from the first mosaic image subjected to the color mixture correction or the second mosaic image,
wherein the first color is formed by a color having a higher contribution ratio for obtaining a brightness signal than the second color.

2. The image processing device according to claim 1,
wherein, when the color mixture information determination unit determines that the color mixture information is identified, the mosaic image acquisition unit reads the first mosaic image from the color imaging element or the mosaic image acquisition unit reads a third mosaic image obtained by reducing the number of types of first pixels from the color imaging element.

3. An image processing device that generates three-layer color data on the basis of a first mosaic image obtained from a single color imaging element in which color filters are provided in a predetermined color filter arrangement on a plurality of pixels that are two-dimensionally arranged, comprising:
a lens information acquisition unit that acquires information of a lens which is used to capture an image;
a color mixture information determination unit that determines whether color mixture information used for color mixture correction is identified or unidentified on the basis of the lens information;
a mosaic image acquisition unit that reads the first mosaic image from the color imaging element;
a mosaic image generation unit, when the color mixture information determination unit determines that the color mixture information is unidentified, that generates a second mosaic image obtained by reducing the number of types of first pixels in the first mosaic image which includes a pixel of a first color formed by at least one color and a pixel of a second color formed by at least two colors other than the first color and in which the number of types of first pixels determined by the arrangement of pixels that are adjacent to a first pixel, which is the pixel of the first color, at a minimum pixel pitch in four directions is equal to or greater than 4;
a color mixture correction unit that performs the color mixture correction for the first mosaic image when the color mixture information determination unit determines that the color mixture information is identified; and
a synchronization unit that generates colors of three layers from the first mosaic image subjected to the color mixture correction or the second mosaic image,
wherein the first color is formed by a color having a higher contribution ratio for obtaining a brightness signal than the second color.

4. The image processing device according to claim 3,
wherein, when the color mixture information determination unit determines that the color mixture information is identified, the mosaic image generation unit generates the first mosaic image or the mosaic image generation unit generates a third mosaic image obtained by reducing the number of types of first pixels.

5. The image processing device according to claim 1,
wherein the second mosaic image is acquired or generated by reducing the number of types of first pixels in the first mosaic image using an extraction process.

6. The image processing device according to claim 3,
wherein the second mosaic image is acquired or generated by reducing the number of types of first pixels in the first mosaic image using an extraction process.

7. The image processing device according to claim 5,
wherein an extraction rate can be changed when the number of types of first pixels is reduced by the extraction process.

8. The image processing device according to claim 6,
wherein an extraction rate can be changed when the number of types of first pixels is reduced by the extraction process.

9. The image processing device according to claim 1,
wherein, in the second mosaic image, the types of first pixels have regularity or a single type of the first pixels is arranged in a first direction and a second direction perpendicular to the first direction, and
the first pixels are arranged on a straight line extending in the first direction.

10. The image processing device according to claim 3,
wherein, in the second mosaic image, the types of first pixels have regularity or a single type of the first pixels is arranged in a first direction and a second direction perpendicular to the first direction, and
the first pixels are arranged on a straight line extending in the first direction.

11. The image processing device according to claim 1,
wherein, in the second mosaic image, the types of first pixels have regularity or a single type of the first pixels is arranged in a first direction and a second direction perpendicular to the first direction,
the first pixels are arranged on the straight line extending in the first direction, and
the first pixel and a second pixel, which is the pixel of the second color, are arranged on a straight line extending in the second direction.

12. The image processing device according to claim 3,
wherein, in the second mosaic image, the types of first pixels have regularity or a single type of the first pixels is arranged in a first direction and a second direction perpendicular to the first direction,
the first pixels are arranged on the straight line extending in the first direction, and
the first pixel and a second pixel, which is the pixel of the second color, are arranged on a straight line extending in the second direction.

13. The image processing device according to claim 2,
wherein, in the third mosaic image, the types of first pixels have regularity or a single type of the first pixels is arranged in a first direction and a second direction perpendicular to the first direction, and
the first pixels are arranged on a straight line extending in the first direction.

14. The image processing device according to claim 4,
wherein, in the third mosaic image, the types of first pixels have regularity or a single type of the first pixels is arranged in a first direction and a second direction perpendicular to the first direction, and
the first pixels are arranged on a straight line extending in the first direction.

15. The image processing device according to claim 2,
wherein, in the third mosaic image, the types of first pixels have regularity or a single type of the first pixels is arranged in a first direction and a second direction perpendicular to the first direction,
the first pixels are arranged on a straight line extending in the first direction, and
the first pixel and a second pixel, which is the pixel of the second color, are arranged on a straight line extending in the second direction.

16. The image processing device according to claim 1,
wherein the type of first pixel is determined by the arrangement of the pixels which are adjacent to the first pixel at the minimum pixel pitch in the four directions and a base structure of the imaging element.

17. The image processing device according to claim 1,
wherein the second mosaic image includes two types of first pixels.

18. An imaging apparatus comprising:
the image processing device according to claim 1; and
an imaging unit including an imaging optical system of a lens interchangeable type and an imaging element on which an object image is formed through the imaging optical system.

19. An image processing method using the imaging device according to claim 1 that generates three-layer color data on the basis of a first mosaic image obtained from a single color imaging element in which color filters are provided in a predetermined color filter arrangement on a plurality of pixels that are two-dimensionally arranged, comprising:
a lens information acquisition step of acquiring information of a lens which is used to capture an image;
a color mixture information determination step of determining whether color mixture information used for color mixture correction is identified or unidentified on the basis of the lens information;
a mosaic image acquisition step of, when the color mixture information is determined to be unidentified in the color mixture information determination step, reading, from the color imaging element, a second mosaic image obtained by reducing the number of types of first pixels in the first mosaic image which includes a pixel of a first color formed by at least one color and a pixel of a second color formed by at least two colors other than the first color and in which the number of types of first pixels determined by the arrangement of pixels that are adjacent to a first pixel, which is the pixel of the first color, at a minimum pixel pitch in four directions is equal to or greater than 4, and when the color mixture information is determined to be identified in the color mixture information determination step, reading the first mosaic image from the color imaging element;
a color mixture correction step of performing the color mixture correction for the first mosaic image when the color mixture information is determined to be identified in the color mixture information determination step; and
a synchronization step of generating colors of three layers from the first mosaic image subjected to the color mixture correction or the second mosaic image,
wherein the first color is formed by a color having a higher contribution ratio for obtaining a brightness signal than the second color.

20. An image processing method using the image processing device according to claim 3 that generates three-layer color data on the basis of a first mosaic image obtained from a single color imaging element in which color filters are provided in a predetermined color filter arrangement on a plurality of pixels that are two-dimensionally arranged, comprising:
a lens information acquisition step of acquiring information of a lens which is used to capture an image;
a color mixture information determination step of determining whether color mixture information used for color mixture correction is identified or unidentified on the basis of the lens information;
a mosaic image acquisition step of reading the first mosaic image from the color imaging element;
a mosaic image generation step of, when the color mixture information is determined to be unidentified in the color mixture information determination step, generating a second mosaic image obtained by reducing the number of types of first pixels in the first mosaic image which includes a pixel of a first color formed by at least one color and a pixel of a second color formed by at least two colors other than the first color and in which the number of types of first pixels determined by the arrangement of pixels that are adjacent to a first pixel, which is the pixel of the first color, at a minimum pixel pitch in four directions is equal to or greater than 4;
a color mixture correction step of performing the color mixture correction for the first mosaic image when the color mixture information is determined to be identified in the color mixture information determination step; and
a synchronization step of generating colors of three layers from the first mosaic image subjected to the color mixture correction or the second mosaic image,
wherein the first color is formed by a color having a higher contribution ratio for obtaining a brightness signal than the second color.
